(19) United States
(12) Patent Application Publication
(10) Pub. No.: US 2012/0144759 A1
(43) Pub. Date: Jun. 14, 2012

(54) Prior art micro screens and expanded metal

(76) Inventors: Edward Higginbotham, Ridgewood, NJ (US); Karen M. Sager, Ridgewood, NJ (US)

(21) Appl. No.: 13/400,229

(22) Filed: Feb. 20, 2012

(51) Int. Cl. E04D 13/076; B01D 63/00

(52) U.S. Cl. 52/12; 210/153

(57) ABSTRACT

A filter assembly that has a filtering method overlying an expanded metal skeletal structure, said expanded metal employing sidewalls that are Long Way of the Diamond having their greatest length parallel to a roofs edge and whose sidewall members are angled toward oncoming water flow, the skeletal structure being attached to a filtering member. The filtering assembly able to be secured to a building by means of a hanging assembly. The hanging assembly comprising a gutter hanger with a rear double hooped element; the rear most hoop engaging an upward raised element of a receiving channel pre-fastened to a fascia board.

When considering any prior art in field 52/12 it is notable that some inventors, myself among them, who taught the use of expanded metal as a water receiving area of a gutter guard, illustrated that the expanded metal was positioned so that, what is known in the expanded metal industry as the LWD: “long way of the diamond” is parallel to water flow off of a roof structure. I taught, by illustration, this in U.S. Pat. No. 6,951,077, Hileman taught this in U.S. Pat. No. 4,592,174 (FIG. 5), and Jones taught this in U.S. Pat. No. 5,592,783 (FIG. 3). A product currently on the market: Leaf Solution®, invented by this applicant, employs expanded metal overlain my micro mesh and in this product the expanded metal's diamond shaped openings are also positioned so that their LWD is parallel to water flow. Not every type of expanded metal employs diamond shaped openings but the same changes in water directing properties of expanded metal openings that occur when you re-position a diamond shaped expanded metal opening, in relation to oncoming water flow, hold true when repositioning any geometrically shaped expanded metal opening. For the purpose of this application, the term “LWO”: “Long way of the opening” will be used going forward.

Other prior art in the field that teaches the use of expanded metal as a water receiving area of a gutter guard illustrates the expanded metal is positioned so that the LWO is perpendicular rather than parallel to water flow. Examples of this are found in U.S. Pat. Nos. 4,036,761 (FIG. 1), 4,959,932 (FIG. 1), and in two gutter guard products presently on the market: Diamond Back Gutter Cover™ and Black Hawk Gutter Defense; sales literature for both gutter guard products included in this application. One more example of this is a product on the market: Sentinel® Gutter Debris Shield which is manufactured under U.S. Pat. No. 5,956,904 and whose product literature is attached to this application.

When I invented the Leaf Solution product I was unaware, at the time, that expanded metal positioned in the manner I had chosen: LWO parallel to water flow, allowed a water overflow that could be significantly reduced if the expanded metal was positioned so that two things occurred. First, the sidewalls of the expanded metal walls that make up a diamond shaped (or any shaped) expanded metal opening should be angled upward and toward oncoming water flow. That property was not and is not existent in the Leaf Solution product. Second, the expanded metal should be positioned so that the LWO is perpendicular to oncoming water flow. I discovered by playing with the Leaf Solution product at Roll Former® Company in Chalfont Pa. that if I repositioned the products underlying support base (the expanded metal that supports overlying micro mesh) so that the LWO was parallel to oncoming water flow, as it is in some Prior Art, the Leaf Solution product directed or pulled a bit more water downward through the overlying micromesh.

As stated earlier, other prior art had already taught, at least by illustration, positioning the LWO perpendicular to water flow. Though it may exist in the language of a patent, I have found no specification addressing this advantage offered by positioning expanded metal openings so that their LWO is perpendicular to water flow. I am guessing that other manufacturers or inventors did as I did: took whatever expanded metal was readily available and shaped it into a gutter guard without considering or noting the ability of “LWO perpendicular to water flow” products To redirect more water flow downward into an underlying rain gutter that “LWO parallel to water flow” products.

However, what no other prior art has taught and no product presently on the market, that I am aware of, employs is a gutter guard that utilizes expanded metal openings in combination with overlying micromesh filtration in which you would find that the expanded metal openings are both perpendicular to oncoming water flow and whose majority of sidewall members are angled upward and toward oncoming water flow. It is the “sidewalls of the opening angled upward and toward oncoming water flow”, in combination with an overlying micro mesh or other filtering method art that this application presents as new art.

There are simple “expanded metal only” (not overlain by micro-mesh or other filter) gutter guard products on the market whose expanded metal openings are both LWO perpendicular to oncoming water flow and whose majority of sidewall members angle upward toward water flow. But there are none on the market or described or illustrated in prior art where it is found that these three properties exist: 1. The expanded metal openings are LWO perpendicular to oncoming water flow 2. The majority of the sidewalls or the largest linear portion sidewall members of the expanded metal openings are angled upward toward oncoming water flow; the top edge of sidewalls faces toward rather than away from oncoming water flow. And: 3. The expanded metal as described in criteria one and two above is overlain by micromesh or other filtering membrane.

There is a range of angle that seems to best capture and redirect oncoming water flow.

A point could be made that it would be obvious to someone skilled in the art to overly an expanded metal base that, even though it may be an inadvertent occurrence, DOES employ expanded metal openings with properties one and two as described in the above paragraph. I would like to offer for the consideration the point that: the “need” to do so to achieve a significant increase in water permeability or downward directing of the water through a micro mesh over expanded metal base combination would not and has not been obvious to someone skilled in the art or it would have been noted in prior art and already accomplished and offered for sale in the highly competitive gutter guard market place.

The U.S.P.T.O. accepted a similar response from me to an examiner's objection in the granting of U.S. Pat. No. 7,913,458 when I presented that, though it seemed obvious that one might place a micro mesh (or more than 80 threads per inch cloth) over louvers since screens of lesser threads per inch had been placed over louvers or other perforated bases, it really wasn't obvious to use a cloth with more threads per inch because it had not yet been done after decades of screen-over-supporting-base gutter guards being issued and the likely reason it hadn't been taught Is that no one would have predicted the ensuing result of greater water redirection versus the use of conventional filtration cloths employing fewer threads per inch. It was obvious to think that a cloth with more threads would keep out smaller debris but no one had ever utilized cloths or screens with more than 18 threads per inch because such 18 threads per inch cloth kept out any debris large enough to clog a downspout opening so . . . why bother? Well, because no one would know, except as the examiner concluded: “except by experimentation and hindsight” that a cloth of not 18, but of 80 or more threads per inch would take as much or more water than filter cloths employing fewer threads per inch if a certain diameter of threads to threads per inch was maintained.

I now hope to present a similar point: when the sidewalls of expanded metal openings are angled in a manner that positions their top or terminal edge away from oncoming water flow, as is found in all micro mesh/over expanded metal products on the market today, it allows the sidewalls to present more surface area to be readily or immediately contacted by oncoming water flow. It would seem logical to conclude that a greater surface area presented by sidewalls that angle obliquely away from oncoming water flow would help to slow water flow and encourage it to drop downward into the open air spaces existing between the side walls. Though this may be true, it is now discovered that, although angling the sidewalls upwards and into water flow and overlying them with filtering cloth presents less readily available water adhesive flow paths for oncoming water, such sidewalls within a certain range of angle and in combination with an overlying micro mesh or filtration cloth, captures and redirects even greater amounts of water downward into an underlying gutter than prior art teaches. The absence of any such prior art or product in the field teaching this new art will, I hope, be viewed as strong evidence that this new art is not an obvious art. Gutter Guard manufacturers and inventors are ever seeking to improve the water permeability of their products, this new art, though easily achieved by repositioning of the underlying expanded metal supporting structure, has not been obvious. I remember the reaction of Bob Schultz, mechanical engineer and part owner of Roll Former Corporation® who has designed many, if not the majority of gutter guard roll forming machines on the market today. When I showed Bob what the repositioning of expanded metal beneath a micro mesh overlay accomplished, he was speechless for a moment: the amount of water this new art redirects downward through itself over prior art is very significant.

A product currently on the market today: Micro CS® offered by Gutter Helmet®, product literature included in this application, utilizes a micro mesh cloth overlying a supporting base of a planar surface out of which arises multiple louvers: concaved semi-circles or hoods with open air faces that do face the oncoming flow of water. This art offers a feature: an angled element facing oncoming water flow just as the present invention offers but the difference between the two arts are significant both visually and also in the area of water permeability. Only a small segment of the “hoods” of the Micro CS product contact the under-surface of the cloth and not nearly as much open air space is provided in this art. The louvers or hoods are positioned in linear rows, not in honey-combed fashion as the openings in expanded metal are, and side by side comparisons illustrate that the Micro CS product redirects much less water through it than the new art described in this application.

### Prior Art Fascia Mounted Hanging Systems

The invention employs concepts related to and, in some instances, extrapolated from prior art disclosed in U.S. Pat. No. 7,104,012 to Bayram, U.S. Pat. No. 7,730,672 to Knudson, U.S. Pat. No. 7,448,167 to Bachman, U.S. Pat. No. 7,748,171 to Barnett, U.S. Pat. No. 7,740,755 to Wilson and Rassor, U.S. patent 6,935,074 to Gramling U.S. Pat. No. 7,752,811 to Pavlansky, and U.S. Pat. No. 7,658,036 to Banks.

### OPERATION OF MAIN EMBODIMENT

Referring to FIG. 29 and FIG. 34 a gutter mounting rail 31 will be attached to a fascia board utilizing screws 30. Referring to FIG. 34: double-rear-looped hangers 29 are inserted into a rain gutter 33. The rain gutter is then lifted into place and hung on the gutter mounting rail 31 that has been prefastened to a building's fascia board 32. This “free hanging” method of installing a rain gutter allows for lateral repositioning of the rain gutter.

An embodiment of the invention: an insertable gutter guard filter 34, is secured to the rain gutter by inserting the rear portion 34f of the gutter guard filter beneath a roof covering or shingles 35 and by ensuring downward extending plane and engaging element 34e is positioned behind upward extending clip 29c of gutter hanger 29. A top solid plane 34d of the invention will rest on the top front lip of the rain gutter. To ensure little or no gap exists between plane 34d and the front top lip of the rain gutter, the invention's downward extending planes 34b and/or 34e may be bent upward and/or upward extending clip 29c of the gutter hanger may be bent downward.

Once installed, the invention serves as a debris blocking water channeling gutter guard in the following manner: rain 5d will flow off of a roofing membrane 35 contacting a micro max sheer cloth (“sheer cloth” as defined in paragraphs 2 and 3 under the heading SHEER CLOTH found in the DESCRIPTION OF AN EMBODIMENT of this application). The close, but not too close, proximity of the threads within the sheer or “micro max” cloth allow the water coating and adhering to each thread to join in a single heavier column of water spanning the open air space between them which encourages the water to “let go” and cease adhering to the threads and continuing forward water flow along the threads and, instead, drop downward. Were the threads too close or to far from one another, this column of water would not form. The water becomes more attracted to the shared central column of water between the threads than it is to the threads themselves and when the column of water is heavy enough it forms and becomes it's own downward (away from the horizontal plane of the cloth) flow path.

Additionally, any water that does cling to the underside of the sheer cloth is interdicted by the angled and upward extending sidewalls 2a of the expanded metal openings: the water forms a greater adhesive bond with the angled sidewalls than to the cloth and begins to channel down the sidewalls and drop into an underlying gutter. When the angle of the sidewalls is not acute enough (less than 20 degrees) or oblique, or too acute (greater than 70 degrees) or the sidewalls are angled away from water flow; less water releases from the cloth. The 20 to 70 degree angle offers both the underside and top side of the expanded metal sidewalls as water flow paths to oncoming water that the water will more readily adhere to than the sheer cloth (or any other similar filtering method) it previously adhered to. When the angle is not quite acute enough, or at 90 degrees or greater, the water tends to “see” or be attracted to only one side of an expanded metal sidewall because only one side is readily or immediately available for contact by water. For example: if the sidewall is at a 90 degree angle, oncoming water “sees” and readily contacts the top narrow plane of the sidewall and only has to dip slightly to adhere to the downward extending face of the sidewall facing it, but the backside of the sidewall which is “hidden” from the view of the oncoming water does not present such a readily available or alternative water flow path so any water not captured an redirected downward by the top and front side of the sidewall tends to remain clinging to the sheer cloth and keep flowing forward. Oblique or slightly acute angles also readily offer one side, rather than two sides, of a sidewall to oncoming water.

It has also been noted in testing that sidewalls that have more length: a deeper extension downward of the sidewall, channel more water by discouraging less forward underflow of water. Shallow depth sidewalls make it more probable that water will “loop” around the bottom of the sidewalls and back up to the underside of cloth and keep on forward flowing.

Any water that would not be redirected downward through the water receiving area of sheer cloth (or other filtering membrane) that overlies expanded metal with properly angled sidewalls will be interdicted and directed downward by downward extending inseam or plane 29. Plane 27 is solid or mostly solid and further directs water that contacts it downward and away from the front lip of the gutter. Vertical columns of water tend to form between plane 27 and the overlying water receiving area of the invention that provide more attractive water flow paths to water than are present when water simply free falls down through the water receiving area.

Side by side testing of the present invention which employs sidewalls angled as described has shown it to be demonstrably more effective at capturing and redirecting water downward and at self-cleaning itself of shingle or other oil that may deposit on the invention.

Any water receiving area of any alternative embodiment of the present invention illustrated or described within this application will operate by the same principles described above in this section: “OPERATION OF THE MAIN EMBODIMENT”. Alternative embodiments shown are mostly structural reconfigurations that may make the present invention more readily adaptable to certain circumstances present at installation sites: certain alternative embodiments may allow for easier installation or more water capture and redirection in certain environments. For example: FIG. 32 illustrates an embodiment of the invention that utilizes a hanging assembly attached to the fascia board of a building structure. This embodiment may be necessary when California Slate style roof coverings or poured rubber roof coatings make it impossible to insert the back edge of an embodiment beneath the roof covering for securing as the Main Embodiment teaches in FIG. 34.

### SUMMARY OF THE INVENTION

With this invention a gutter guard system is provided for a gutter which includes an expanded metal water receiving and water re-directing area overlain by a filtering membrane.

The expanded metal is expanded “The Long Way of the Diamond” in relation to the expanded metal's longest edge and in relation to a building's fascia board and oncoming water flow off of a building's roof: the openings defined by sidewalls existent in the expanded metal have a length greater than width and the length is parallel to oncoming water flow.

At least two sidewalls of any expanded metal opening angle upward and into oncoming water flow. The expanded metal opening is then overlain by a filtering membrane.

Positioning the expanded metal “Long Way of the Diamond” in relation to oncoming water flow and ensuring at least two of the expanded metal openings' sidewall members are angled upward and forward into water flow, rather than parallel or nearly parallel to it, creates strong downward flowing water flow paths in conjunction with overlying micro mesh or other filtering membrane materials.

### BRIEF DESCRIPTION OF THE DRAWINGS

FIG. 1 is a view of an expanded metal gutter guard employing an expanded metal pattern composed of openings “expanded vertically to the long side”

FIG. 1a is a view of an expanded metal opening “expanded vertically to the long side”, also termed: “short way of the diamond”

FIG. 1b is an exploded view of a segment of an expanded metal gutter guard employing an expanded metal pattern composed of openings “expanded vertically to the long side”

FIG. 2 is a view of an embodiment of the invention: an expanded metal gutter guard employing an expanded metal pattern composed of openings “expanded horizontally to the long side”

FIG. 2a is a view of an expanded metal opening “expanded horizontally to the long side”, also termed “long way of the diamond”

FIG. 2b is an exploded view of a segment of an expanded metal gutter guard employing an expanded metal pattern “expanded horizontally to the long side”

FIG. 3 is a view of an expanded metal opening “expanded vertically to the long side” illustrating side wall components

FIG. 3a is a view representative of angles of tilt and water flow paths that exist in sidewall members of an expanded metal opening “expanded vertically to the long side”

FIG. 3b is a view of an expanded metal opening “expanded vertically to the long side” showing water flow paths along it's top surface

FIG. 3c is a view of micro mesh filtration cloth

FIG. 4 is a view of an expanded metal opening “expanded horizontally to the long side” illustrating top and bottom surfaces existent in each side wall member

FIG. 4a is a view of side wall members of an expanded metal opening “expanded horizontally to the long side” illustrating water flow paths

FIG. 4b is a view of an expanded metal opening “expanded horizontally to the long side” illustrating water flow path patterns that initiate on the top surface of side wall members of the expanded metal opening

FIG. 4c is a view of micro mesh filtration cloth

FIG. 5 is a view of an expanded metal opening “expanded horizontally to the long side” illustrating height and width and separated individual side wall members of the expanded metal opening

FIG. 5a is a view of an isolated side wall member of an expanded metal opening “expanded horizontally to the long side” illustrating angles of tilt and bevel existent in itself and associated side wall members.

FIG. 6 is a view of an expanded metal opening “expanded horizontally to the long side

FIG. 6a is a view of a side wall member of an expanded metal opening “expanded horizontally to the long side in a corrugated embodiment

FIG. 7 is a view of an embodiment of the invention overlain by micro mesh filtration cloth

FIG. 8 is a view of an embodiment of an expanded metal opening “expanded horizontally to the long side” with a center member

FIG. 9 is a view of micro screen or cloth with warp and weft threads approximately equi-distant from each other in all directions

FIG. 10 is a view of micro screen or cloth with weft threads spaced more closely to one another than warp threads

FIG. 11 is a view of a twisted or “cork screwed” thread

FIG. 12 is a view of a metallic thread micro screen

FIG. 13 is a view of a metallic thread micro screen with rectangular patterns depressed or embossed into the cloth

FIG. 14 is a profiled and top perspective view of a rectangular shaped well that has been depressed or embossed into the cloth

FIG. 15 is a view of a gutter guard employing a water receiving area composed of a metallic thread micro screen with various shaped patterns recessed or depressed downward into the metallic cloth

FIG. 16 is a view of a recessed or downward embossed heart shape illustrating water flow patterns

FIG. 17 is a view of a recessed or downward embossed rectangular “bow tie” shape illustrating water flow patterns

FIG. 18 is a view of the invention affixed to a rain gutter

FIG. 19 is a view of a metallic thread micro screen or cloth with word phrases depressed or embossed downward into it's top surface

FIG. 20 is a view of a metallic thread micro screen or cloth with depressed or recessed shapes (embossed downward) out of which arises an upward embossed plane or shape and which incorporates a downward extending inseam

FIG. 21 is a view of larger diameter threads

FIG. 22 is a view of smaller diameter threads

FIG. 23 is a view of smaller diameter threads more closely spaced

FIG. 24 is a top view of expanded metal that has been expanded horizontally to the long side into which has been embossed or depressed wells or channels

FIG. 25 is a top view of expanded metal that has been expanded horizontally to the long side into which has been embossed or depressed wells or channels and which is covered with a filtration membrane

FIG. 26 is a view of an embodiment of the present invention illustrating a reverse curved drip edge element with a gutter guard receiving channel, with gutter guard inserted

FIG. 27 is a view of an embodiment of the present invention illustrating a reverse curved drip edge element with a rear engaging sleeve

FIG. 28 is a view of a gutter hangar exhibiting two rear clip elements

FIG. 29 is a view of a dual channeled rail that serves as a gutter guard and gutter hanging assembly

FIG. 30 is a view of an embodiment of the present invention attached to the fascia board of a building

FIG. 31 is a view of a filtration element that employs solid lower water directing planes

FIG. 32 is a view of an embodiment of the present invention attached to a building structure and illustrating water flow paths

FIG. 33 is a view of an embodiment of the present invention

### DESCRIPTION OF AN EMBODIMENT

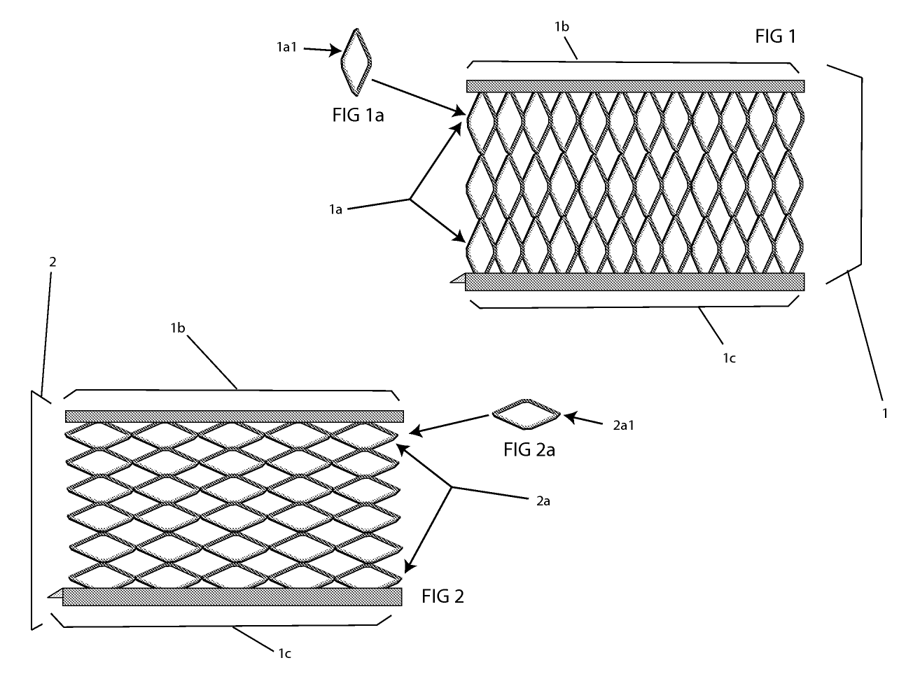

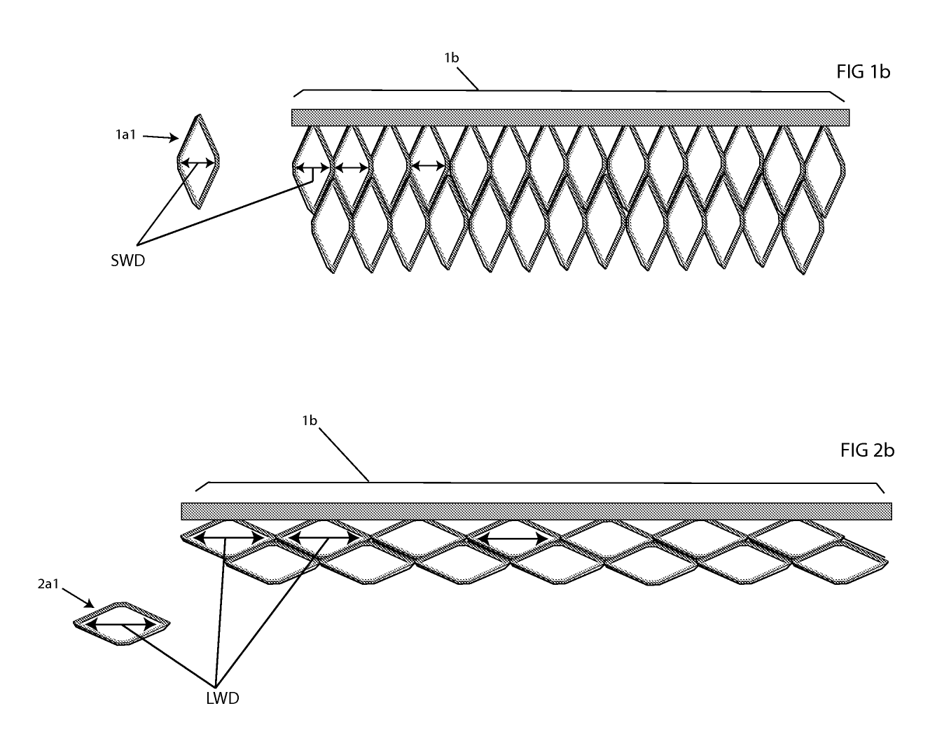

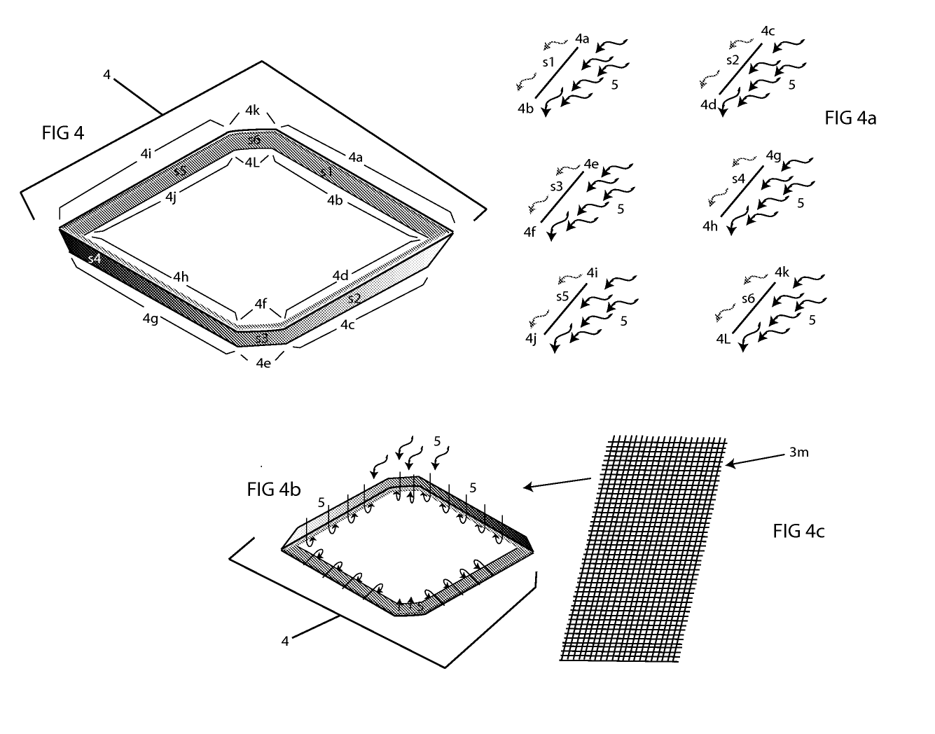

Referring to (FIG. 2b) this embodiment teaches the utilization of expanded metal that employs openings whose longest measured air space 2a1 is longitudinally parallel to the longest edge 1b of the sheet or roll of the expanded metal they exist within and whose sidewall members are angled upward from the original plane of metal they have been created from. Referring to (FIGS. 4, 4a and 4b). This allows for the expanded metal to be placed over a rain gutter in such a manner that each sidewall member, or the majority of sidewall members, of each punched opening is facing the oncoming flow of water off of a roof structure. Expanded metal exists as both “flattened” in which the sidewall members are flat; not angled, and as “standard” or “angled side wall members”. The present invention employs “Standard” expanded metal that is then coupled with a “sheer” filtering overlay for the purpose of preventing debris entrance into a gutter while redirecting water flow into a rain gutter.

### Sheer Cloth

Prior art found in field 52/12 states that when screens or cloths are made too fine: more than 18 threads per inch, in an attempt to block smaller debris, they begin to fail at allowing water to pass through them and therefore do not serve well when utilized as a screening or filtering component of a gutter guard. This thought is expressed throughout field 52/12, a most recent example being a recitation of this maxim which is found in U.S. Pat. No. 6,164,020 granted to Nitch, column 1 lines 25-40: “the gutter screens with the larger gutter screen openings tend to have a problem with leaves and debris becoming ensnared on the gutter screen. The leaves and debris which should become ensnared on the gutter screens block the gutter screen openings preventing the passage of water into the gutter. Consequently, gutter screens with larger screen openings tend require periodic cleaning more frequently. Gutter screens with the smaller screen openings generally allow too much water to bypass the gutter and flow over the edge of the gutter. During heavy rainfall, the smaller gutter screen openings are either not able to divert enough water into the gutter or are not able to handle the heavy flow of water entering into the gutter screen openings. Consequently, water flows over the gutter screen and onto the side of the building defeating the purpose of the gutter.”

I have discovered that this concept does not hold true if an “other-than-standard-dimension” screen or cloth wire is not utilized as a filtering membrane: In fact, the opposite becomes true, increasing thread count can actually increase water flow through rate if the diameters of the threads are small enough to ensure a percentage of open area of at least 35% or greater exists in the micro screen or cloth. When this is the case, openings between threads can be so small as to prevent the tiniest of debris into a gutter while enabling the micro screen or cloth to take as much or more water than screens or cloths employing much larger openings between threads. My colleague John Doyle terms this property of physics “micro-max” flow rate when I explained it to him: I like the term and will use it in this application [symbol] . Simply stated “micro-max” flow rate defines: an increase in both debris blocking ability and water permeability of a filtering screen can be achieved by maximizing or increasing thread count while decreasing or “miro-sizing” thread diameter.

Within this application, the term micro-mesh or “micro-max” or “sheer cloth” will refer to square mesh or rectangular mesh or metallic-thread screen cloth composed of now fewer than 60 threads per inch such cloth having an percentage of open area equal to or greater than 35% (thirty five percent) or micro screen composed of no fewer than 60 threads per inch, such threads-being smaller than the smallest thread diameters commonly denoted as “standard size” and that are commonly available and published in standard thread diameter charts or in catalog offerings by companies that manufacture square or rectangular mesh micro screen or cloth products. As an example; most steel wire cloth manufacturers publish available thread diameters of approximately 0.075 mm to 0.09 mm for their manufacture of 120 threads per inch square mesh wire cloth. However, the “sheer” cloth I requested and tested, and not commonly offered, is composed of 120 threads per inch threads with diameters of 0.056 and 0.057 which are approximately 25% (twenty five percent) smaller than the standard 0.075 mm thread found in 120 mesh stainless steel micro screen.

Wire cloth dimension tables from Cleveland Wire Cloth® and from Anping Senming® Wire Cloth company are attached to this specification. Additionally, www.wovenwire.com publishes a table of standard wire cloth dimensions denoting common wire diameters utilized in the manufacture of specific numbered threads-per-inch wire cloth and meshes. Research will show that these three tables represent common industry standards and that what various companies and industry leaders denote as “standard diameters” does not vary by more than 15%. These published industry standard diameter dimensions are the dimensions used within this specification to denote “standard” thread diameters. As stated earlier: it is from these published dimensions of standard thread diameters that this specification's definition of “sheer” is derived: sheer micro screen or mesh or cloth is one that is composed of threads with diameters smaller than the smallest published diameter found among the three published industry standard diameters for any square or rectangular mesh metallic cloth of any particular thread count, and/or cloth or screen that is composed of 60 or more threads per inch such cloth having 35% or more open air space.

### Expanded Metal

Referring to (FIG. 1b) presently, the most common method in which metal is expanded is to employ a punching process that results in “vertical expansion to the long side”. This industry term describes the positional relationship of the individual expanded openings in relation to the horizontal length of a coiled roll of expanded metal: Referring to (FIG. 1b) 2a1 and 1b, “vertical expansion to the long side”, also termed: “short way of the diamond” indicates that an elongated expanded metal opening's longest measured air opening is perpendicular to the longest edge of the expanded metal sheet or roll.

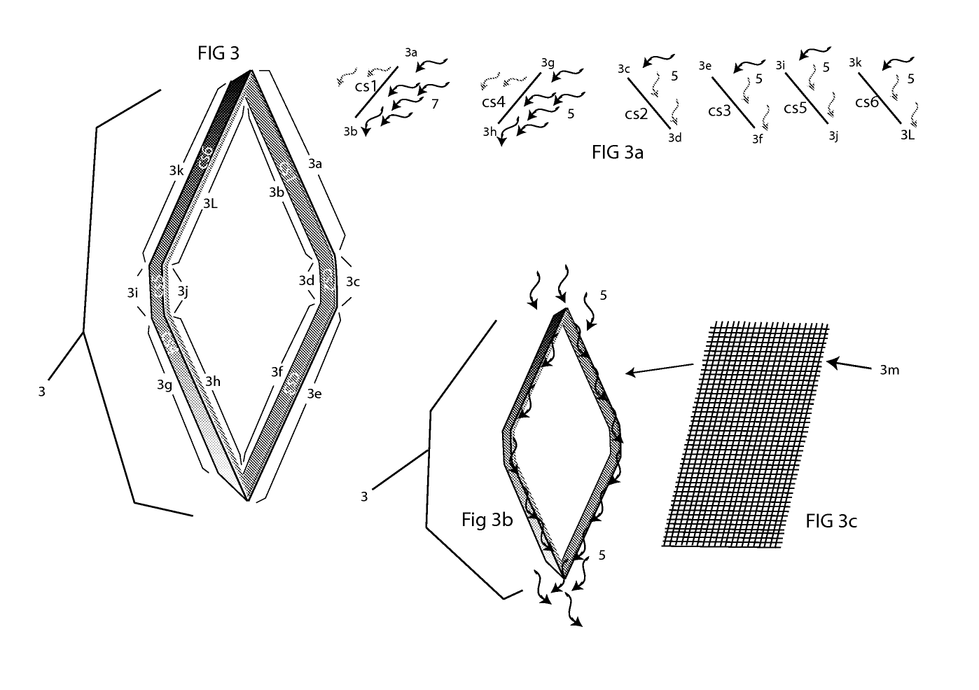

Referring to (FIG. 3 and 3b) when expanded metal that has been expanded to “the short side of the diamond”, also referred to as “SWD” is utilized as a gutter guard device, the punching and tearing dies are positioned in such a way that they create sidewalls for the expanded metal openings that present a mostly flat top surface which parallels water flowing off of a roof structure. When forward flowing water contacts this type of “short way of the diamond” pattern it tends to stay on the top surface of the diamond opening's sidewall members and flow over and past the underling gutter. This pattern of water flow past an underlying gutter, rather than down into it, is exacerbated when filtering methods overly expanded metal employing “short way of the diamond” openings which, until the present invention, is to the best of my knowledge, the only known screen-over-expanded metal type of gutter guard disclosed in Prior Art or offered for sale. Sidewalls not positioned more perpendicular to water flow and not angled upward to face oncoming water flow in such a manner that the top most edge of each side member “slices” through the oncoming water flow have proven to be only partially effective at capturing forward flowing water and redirecting it downward.

The “horizontal expansion of the long side” also known as “Long Way of the Diamond” or; “LWD” method of expanded metal punching is employed by some manufacturers of expanded metal: referring to (FIG. 1b) this type of metal expansion produces horizontal lengths of expanded metal that have the longer side of their expanded metal openings 2a1 run parallel to the length of an expanded metal roll of material, allows a previously undiscovered or non-disclosed opportunity for a length of, (referring to FIG. 7) 2a, such expanded metal to be coupled with a filtering membrane and positioned so that every sidewall of the expanded metal opening presents top surfaces of the sidewalls that are mostly perpendicular to water flow and are angled upward and into oncoming water flow as disclosed in (FIG. 4a) allowing for greater capture and redirection of oncoming water flow.

However, simply utilizing “LWD” patterned expanded metal (the expanded metal openings would have their longest dimension parallel to a roof line or fascia board) as a gutter guard or water receiving area for water coming off of a roof does not result in much, if any improvement in water redirection downward. I say this because whenever “LWD” openings are created they are created with angled sidewalls that may be pointed toward or away from oncoming water flow and the top edge and bottom edge of the sidewall may be either narrow and “sharp” or broad and flat. The present invention teaches that the LWD sidewalls must be placed not solely in a position parallel to water flow and then overlain by micromesh; the present invention additionally teaches that two or more of the sidewalls composing the diamond openings must be angled upwards toward oncoming water flow off of a roof and that it is preferable if the top edge angling toward water fall is also a narrower rather than broader width.

Referring to the drawings wherein like reference numerals represent like parts throughout the various figures, reference numeral 2 (FIG. 2a) discloses a gutter guard employing 2a a pattern of expanded metal openings 2a1 (FIG. 2a) formed with horizontal widths greater than or equal to their vertical heights.

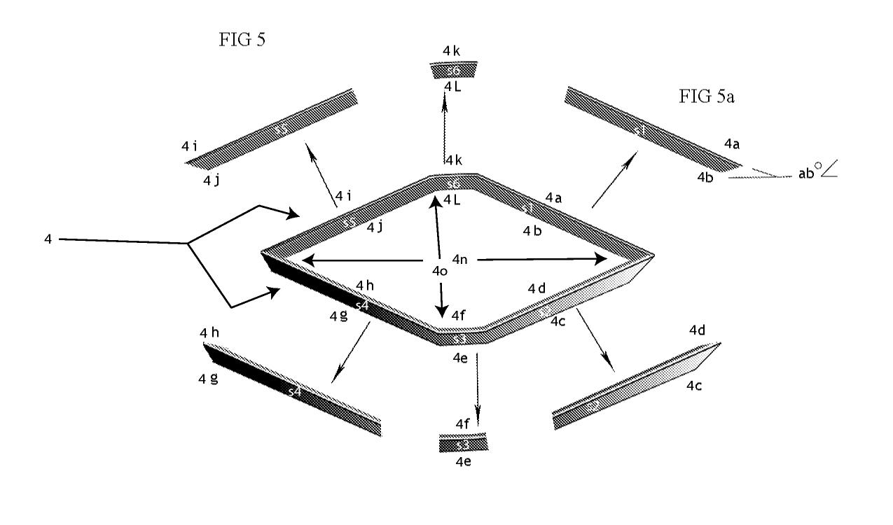

Referring to (FIG. 5) it is shown that the expanded opening 4 is composed of sidewalls s1,s2,s3,s4,s5, and s6. Referring to (FIG. 5a) sidewall s1, is shown as possessing an angle of tilt, from it's top surface 4a to it's bottom surface 4b that may vary from 1 degree to 45 degrees.

This angle is in reference to the horizontal top surface of the flat sheet of metal or plastic from which it was formed. This same angle of tilt exists in sidewalls s2,s3,s4,s5,s6.

Referring to (FIGS. 4 and 4a) it is shown that sidewalls s1,s2,s3,s4,s5,s6, each are beveled and angled in a direction in which their top surface is angled toward and face oncoming 5 water flow from a building's roof structure. Prior art and marketed product have not noted or employed this positioning of each sidewall member of an expanded metal opening for use as a gutter guard.

Utilizing expanded metal that has been “horizontally expanded to the long side” allows the expanded metal pattern (FIG. 2) 2a to capture and redirect water downward (FIG. 4a) in far greater volume than can be achieved by prior expanded metal patterns which offer only 2 sidewall members (FIG. 3a) cs1,cs4 or, in some cases, two small thread junctures that capture and redirect water in similar fashion. What is termed “vertical expansion of the long side” has been the expanded metal pattern employed by gutter guard products that utilize a fine, but not sheer, micro screen overlying expanded metal. Examples of this are found in the currently marketed Leaf Solution® and IG2® gutter guard products. This type of pattern, as noted earlier in this disclosure, does not allow for all sidewalls to be optimally angled for water capture and redirection. Referring again to (FIG. 3a) it is illustrated that sidewalls cs2,cs3,cs5, and cs6 possess top surfaces 3c,3e,3i,3k that are tilted away from oncoming water flow and possess less ability to readily capture and redirect water downward. When water contacting an expanded metal gutter guard that has “vertical expansion of the short side” it tends to flow along the top surfaces of the expanded metal top surface of each expanded metal opening as illustrated in (FIG. 3b) 3, rather than to flow down each sidewall and into an underlying rain gutter.

Overlying such vertically expanded opening with micro mesh (FIG. 3c) 3m or other filtration members seems to exacerbate this phenomenon, most likely due to strong water adhesion bonds created at the points of contact between the micro mesh causing water to cling to both the bottom of the micromesh and top surface of the expanded metal openings and continue flowing forward to the front lip of a gutter rather than downward into it. I first noted this in my U.S. Pat. No. 6,951,077 (claim 1, Par 18 lines 67 and Par 10 lines 1,2,3). in which I taught the breaking of the forward flow of water by employing downward inseams comprised of micro mesh cloth and expanded metal extending downward into a rain gutter. A similar breaking of the forward flow of water and redirection of it downward is achieved by the angled positioning of the sidewalls of expanded metal openings upward and into oncoming water flow. The more recent and limited “horizontal expansion of the long side” employed by some manufacturers of expanded metal allows, but does not ensure, a previously unknown or non-disclosed opportunity for every sidewall of the expanded metal opening to be angled so that the top surfaces of the sidewalls are angled upward and into oncoming water flow as disclosed in (FIG. 4a) allowing for greater capture and redirection of oncoming water flow.

There is one known gutter guard company recently formed and doing business as Diamondback™, that does utilize metal horizontally expanded to the long side, or LWD, overlain with a fine, but not sheer, stainless steel mesh screen but a critical flaw in the product that inhibits it from redirecting water flow as effectively as the present invention is that the majority of sidewalls of the LWD openings are angled away from, not toward oncoming water flow. I point to this as a “critical flaw” or critical difference between the product and the present invention because of a readily demonstrated ability of the present invention's much greater Ability to capture and redirect forward flowing water downward due to the present invention's unique positioning of the sidewalls of a LWD pattern: ie; forward into oncoming water flow. water than the Diamondback gutter guard. Diamond back advertising also describes the mesh as “having openings not too small, not too large” the openings being 2/100 inch. This type of larger diameter thread mesh with comparatively (to sheer micro mesh employed by the present invention) much larger air space openings allows pine needle tips and quite a bit of other small organic debris as well as shingle grit to pass through the mesh and into the gutter and does not exhibit the capabilities and improvements existent within the present invention that are described within this specification and have been shown to materialize only with the utilization of what is described in this specification as “sheer” micro screen or micro mesh or micro cloth.

In prototype, overlying expanded metal openings that have been “horizontally expanded to the long side” (FIG. 4b, 4c) 4,3m with “sheer” micro mesh or micro screen (cloths or screens with thread counts of at least 80 threads per inch and thread diameters at Icst 15% smaller than threads commonly manufactured and utilized for a particular mesh/inch count) or other sheer filtration medium provides the shedding of even micro debris: debris as small as 50 microns; dependent on threads per inch of the micromesh, while simultaneously capturing and redirecting water downward through the screen and down the sidewalls (FIG. 4b) 4 of expanded metal openings into an underlying gutter. Testing has shown that this combination of sheer micro screen overlying this type of underlying skeletal structure captures as much, or more forward flowing water as any 5 inch or 6 inch rain gutter can intake without overflowing. Equally, and perhaps more importantly, this combination of sheer micro cloth or micro screen overlying expanded metal expanded to the “long way of the diamond” exhibits an ability to more quickly clean itself of waterproofing oil elements than any known gutter preclusion method including: reverse curved, screened, louvered, perforated, screens and fine screens and micromesh overlying other underlying skeletal structures, and combinations of such as are currently marketed today. I have tested the present invention's ability to self clean itself of oil deposits against all manner of gutter guard devices marketed today, including the Leaffilter® and Gutter Glove® micromesh systems (chosen by Consumer Reports® in a 2010 fall issue as top performing in the DIY and Dealer installed categories . . . Leaffilter being my invention) as well as Gutter Helmet's® CS product and other major brands and technologies and am able to demonstrate that the present invention performs significantly better. It almost instantaneously cleans itself of heavy and other oils exhibiting little to no sign of water-proofing and water run-off exhibited by other methods. Oil leaching out of roofing shingles and organic debris is a main, if not primary, cause of most gutter guard failure in the field: they become water-proof and tend to overshoot water past a rain gutter rather than down into a rain gutter.

A product currently marketed as Leaf Solution® employs a micro mesh but not a sheer micro-mesh screen overlying an expanded metal pattern employing openings expanded “the short way of the diamond” or SWD and it has been shown to have far less ability to capture and redirect water downward into an underlying gutter than prototypes of the present invention. Leaf Solution employs many elements of my U.S. Pat. No. 6,951,077 which teaches a filter method overlying a supporting skeleton of expanded metal that employs downward extending inseams. At the time I invented Leaf Solution, to the best of my knowledge, neither I nor anyone else had yet discovered or tested combining micro-mesh or filtering methods with expanded metal expanded “the long way of the diamond.” The Leaf Solution product, which employs a “short way of the diamond” pattern tested against the present invention, which employs a “long way of the diamond” pattern offers a convincing demonstration of the “long way of the diamond's” greater ability to redirect water flow downward and self clean of oil, provided the sidewalls of the LWD method are angled upward and toward oncoming water flow.

“Long way of the diamond” patterned gutter guard devices with no overlying filtering membrane have been offered in the past and so have “short way of the diamond” patterned gutter guards. Both patterns; “long way” and “short way” of the diamond take equal amounts of water in medium or heavy rains when not overlain by a filtering method. In light rains, SWD gutter guards should tend to track more water forward rather than downward but once water volume reaches a certain point, enough strong downward flow paths off of the sidewalls into the rain gutter are established and SWD gutter guards perform pretty much the same as LWD gutter guards. However, a “long way of the diamond” patterned gutter guard overlain by a sheer micro-screen filtering method has never been disclosed in Prior Art Applications and never offered for sale or marketed to the best of my knowledge. I don't believe anyone knew of the significant difference such a pattern choice offers when in combination with an overlying filtering method: When I first tested the combination I was greatly surprised at how much more water the sidewalls of the diamonds (overlain by micro-mesh) were able to capture and redirect downward into an underlying gutter compared to gutter guards, such as my Leaf Solution invention, that employed a “short way of the diamond” underlying skeleton overlain by micro-mesh or other filtering membranes.

Without being overlain by micro-mesh or screen, expanded metal gutter guards show no difference in their ability to receive water off of a roof and redirect it's forward flow downward into an underlying rain gutter. In fact, “long way of the diamond” gutter guards are more subject to trapping and holding debris than “short way of the diamond” gutter guards because the “LWD”

Greater depths or downward extending vertical lengths (FIG. 4) 4a-4b, 4c-4d, etc. of the sidewalls has been shown to capture heavier flows of water.

Vertical height of the sidewall can't be made too long because more surface area gathers more oil and pollen deposits that must be cleaned by down flowing water. Vertical height of the sidewall can't be made too short because an underflow of water will occur in which water will sheet on the underside of the micro screen and shallow expanded metal and cling to both their undersides and flow forward. The preferred dimensions of expanded metal openings that have been “horizontally expanded to the long side” are ones in which the horizontal width (FIG. 5) 4n is equal to or less than 15 mm and the vertical height (FIG. 5) 4o is greater than 0.9 mm and less than or equal to 8 mm.

Referring to (FIG. 7) 2, a simple manufacture-to-market embodiment of the invention can be achieved by banding lengths of standard expanded metal that has been “horizontally expanded to the long side” and overlying sheer micro mesh with metal sleeves 1b,1c commonly employed by marketed gutter guards. “Horizontally expanded to the long side” openings as small as 5 mm or 2/10 inch wide can currently be achieved; such small openings serving as a somewhat effective gutter guard without the overlayment of micro screen however, referring to (FIG. 7), overlying the “horizontally expanded to the long side” pattern 2a with sheer micro mesh 3m, then banding 1b,1c, will achieve a very effective and very inexpensively manufactured gutter guard able to shed small debris and capture and redirect significant amounts of rain water into an underlying rain gutter.

### Another Embodiment

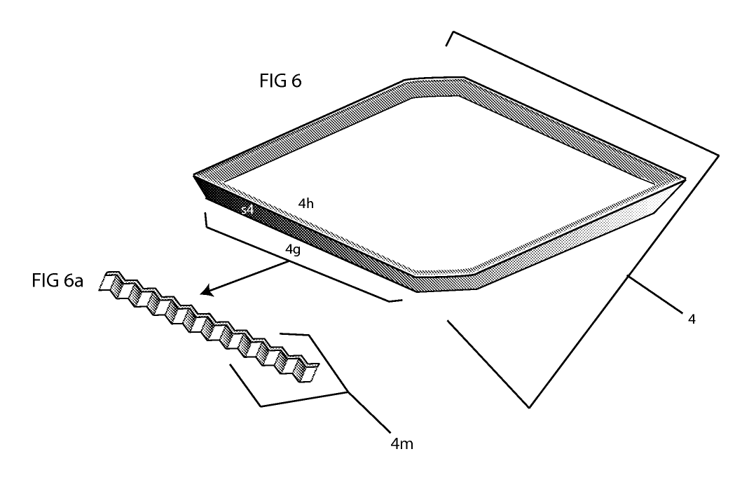

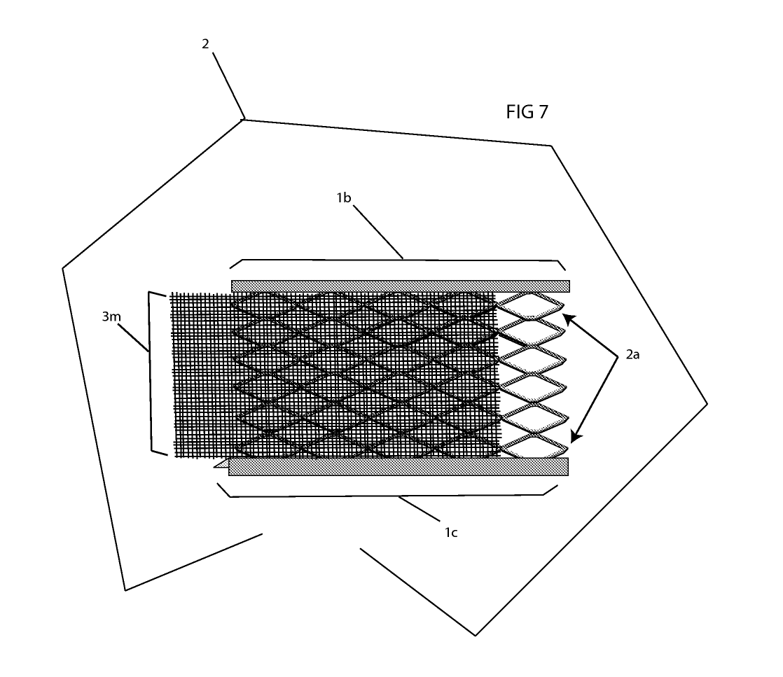

Referring to (FIG. 6,6a) it is illustrated that sidewalls such as s4 composing the expanded metal opening may be corrugated 4m.

### Another Embodiment

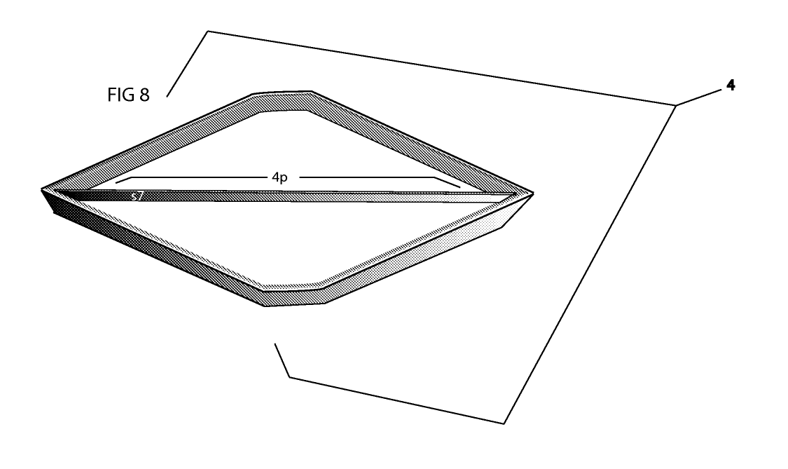

Referring to (FIG. 8) it is illustrated that center members 4p: also shown as s7, may be added to provide more surface area for water to contact. These members would also present top surfaces angled toward oncoming water flow.

### Another Embodiment

### Non Uniform Warp and Weft

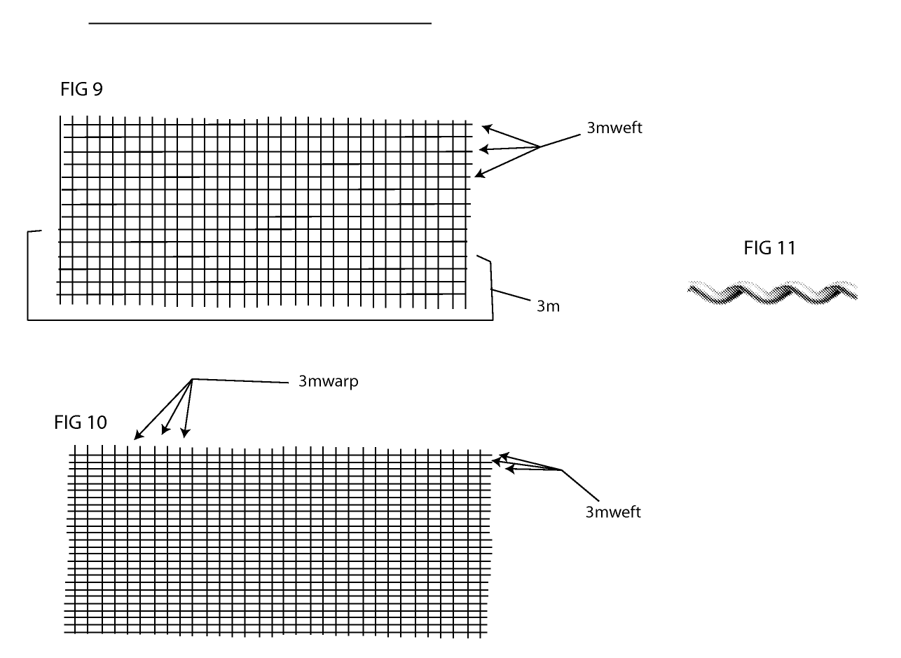

Referring to (FIG. 9) 3m there is illustrated a screen or cloth in which the warp threads 3mwarp of a micro-mesh cloth and the 3mweft threads are spaced equi-distant or nearly equidistant from each other.

Referring to (FIG. 10) Testing has shown that when the 3mweft threads are spaced more closely than the 3mwarp threads, creating more oblong or rectangular shaped air openings in the cloth, more water is captured and redirected downward by such a constructed cloth if the longer side of the rectangular opening is positioned perpendicular to oncoming water flow, than is captured and redirected downward by cloth employing warp and weft threading that is approximately equidistant in all directions creating somewhat uniformly sized and shaped air openings between warp and weft threads. This present invention may employ either: cloth of uniform, or non uniform, warp and weft since both types of woven or knitted micro cloth materials prove very effective at channeling and redirecting water when employed as taught in this specification. Non uniform warp and weft however is preferred but cost and availability may encourage the utilization of more uniformed warp and weft cloth.

Warp knitted cloth has so far proven to be the most effective at water capture and redirection, when employed as taught in my earlier patents and in this specification, but is not, to date, a type of weave that can be achieved in metallic threaded cloths.

When employing metallic threaded cloth; non uniform warp and weft screens or cloths overlying standard expanded metal that has been expanded “the long way of the diamond” allows the present invention to capture the greatest amount of oncoming rainwater flowing toward it than filtration cloths and micro screens utilizing more uniform warp and weft construction which are now commonly employed by gutter guard devices available in the market place today. However, whether using uniform or non-uniform warp and weft, ensuring the mesh or screen is sheer by utilizing small diameter threads and achieving at least 35% open air space will enable the sheer cloth to counter-intuitively become very water permeable even when the cloth is held at an angle while receiving on-coming water. Typically, non sheer multi threaded cloths of more than 80 threads per inch will shed water much like a tent cloth does when held at an angle, sheer cloth much more readily directs the water downward through itself although it may appear solid.

Referring to (FIG. 11) it is noted that the warp and weft threads themselves may be twisted or “cork screwed” which offers further resistance to the forward flow of oncoming water and enables cloth or screens employing such twisted or “cork screwed” threads to redirect water more effectively into downward flow with water more likely to release from the bottom of the thread and drop downward.

### Another Embodiment

### Embossed Shapes

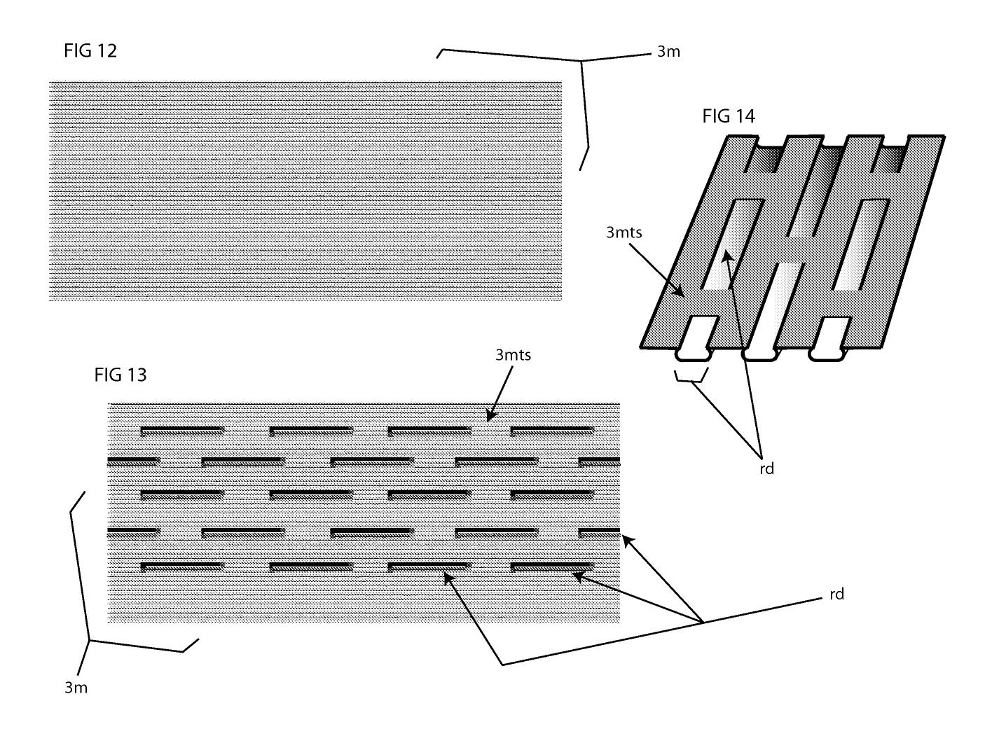

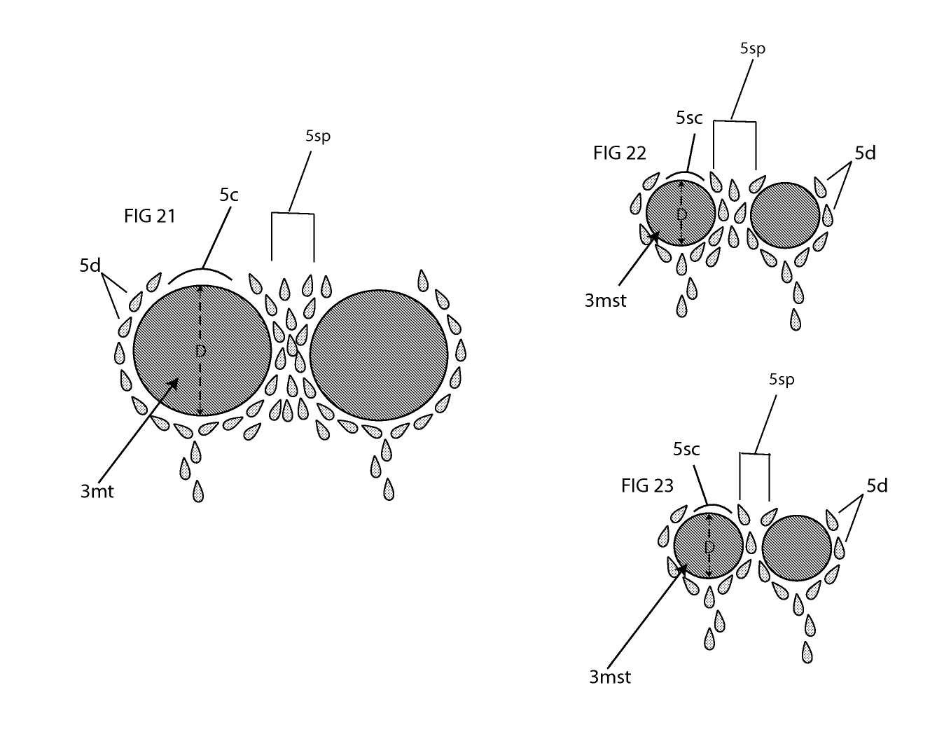

Referring to (FIG. 12) 3m there is illustrated a metallic thread micro screen or filtration membrane exhibiting a thread count of 80 threads per inch or greater. This number, or a greater number of threads per inch, produce a micro screen or micro mesh that is cloth-like in appearance. Referring to (FIGS. 13 and 14): when the threads of such a micro screen or mesh 3m are of a sufficient hardness, recessed or depressed patterns rd may be embossed downward into the 3mts top surface of the cloth. In this embodiment, the micro screen may function unilaterally as a gutter protection method without the necessity of an underlying support skeleton of expanded metal or of any other material of configuration contacting the underside of the micro screen. Downwardly embossed shapes or downwardly extending inseams (Referring to FIG. 21) have been observed to capture the forward flow of water, that normally occurs though a micro screen tilted at an angle, and redirect it downward into an underlying gutter. If the cloth is of sufficient stiffness it may serve, unilaterally when embodied as described, as a gutter protection device in and of itself in areas void of heavy snow load. In regions where snow or other weight commonly occurs on roof and gutter structures an expanded metal and micro screen combination may be preferred due to the greater structural integrity offered by the combination.

Referring to (FIG. 16) 5 water flow paths are illustrated reaching the outer edge of a heart shape that has been recessed or depressed downward. As is illustrated; when shapes are depressed downward into metallic thread micro screen or cloth water is far more likely to reach the outer edge of the shapes and flow downward into them, rather than around them; as it does when it reaches the outer edge of perforations or shaped perforations that have been punched through a solid metal plane. The reason water is more likely to reach the outer edge of such recesses and flow downward is due to the fact that the water is not only flowing across the tops of closely spaced cylinders that form the outer edges of the recessed shapes, it is also slowly around the outer surfaces of the soldiers downward. Water flowing only along the top of a solid plane tends to flow around rather than downward into a punched hole or depression; at least to a greater extent than when water flows on and through a micro screen until it reaches a depressed or recessed shape. A somewhat related example of this tendency of water to be re-directed to a greater extent by cylindrical paths is the employment in Japan and Asian nations of water directing chains at the end of the roofline rather than rain gutters.

Referring to (FIG. 16) 6,7, note that the left 6 and right 7 lowermost areas of the heart shape present a downward extending area ideal for redirecting water 5a downward into the recessed area.

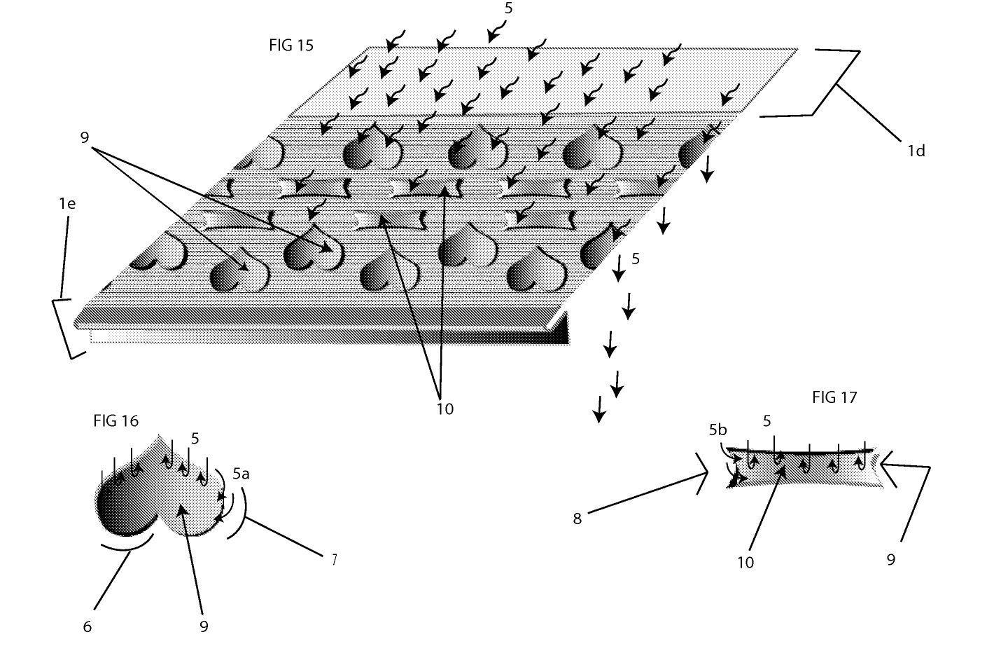

Referring to (FIG. 17) 5, 5b, 8, 9, is again illustrated that water flow paths 5 and 5b tend to channel downward from the cylindrical threads of the micro screen into top heads side edges of the recessed area. My personal testing indicates that the amount of water flowing downward from a planar surface when compared to water flowing downward into depressions made in metallic thread micro screens can only be equaled utilizing solid planar surfaces when they employ downward or upward extending louvers. Tapered punches sometimes employed by gutter guard devices also tend to direct water down more rest and that a “straight through punch” but still not as effective in as depressions recessed shapes made in metallic thread micro screens.

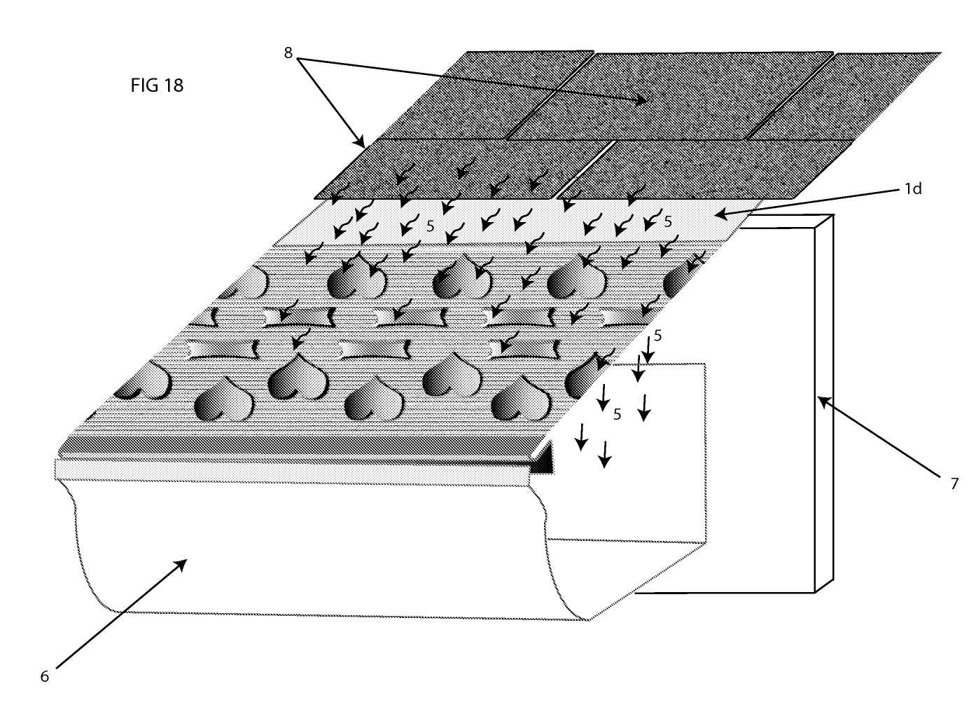

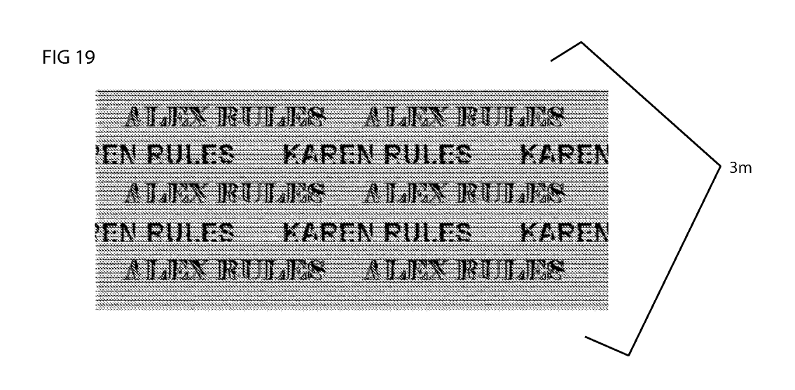

Referring to (FIGS. 18 and 19) 9,10,11,12,13,14 various shapes are shown representative of the types of patterns that may be embossed recessed into metallic thread micro screen cloths. 9: heart shape, 10: paw prints, 11: bowtie, 12: polygon, 13: a word phrase; “ALEX RULES”, 14: a word phrase; “KAREN RULES”. Testing has shown that shapes which employee curved sidewalls such as a heart shape 9 more inwardly extending sidewalls such as a bowtie shape 11 are effective and redirecting water flow into and down side wall area. Decorative shapes such as animal tracks, trees, or other shapes may be employed for functional and/or for marketing or other purposes.

### Another Embodiment

### Islands

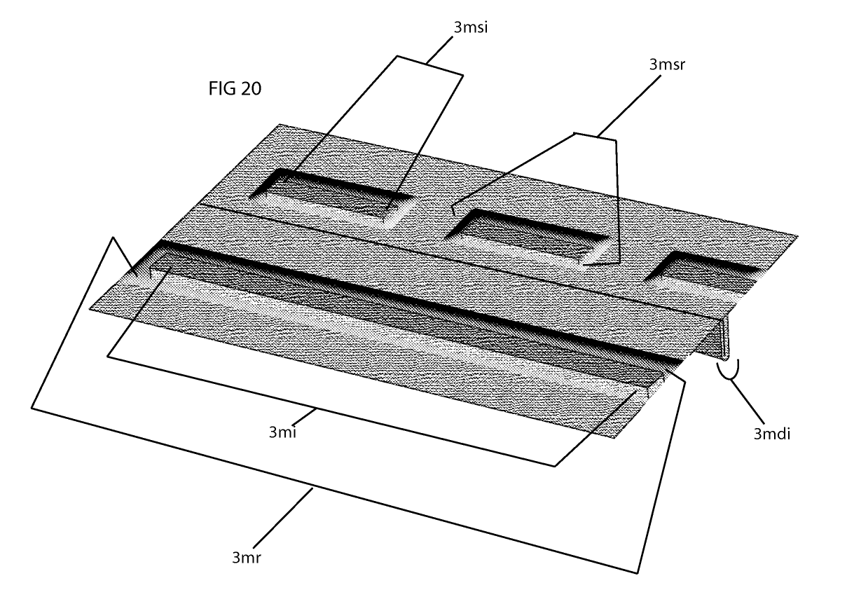

Referring to (FIG. 20) 15,16,17,18, a metallic thread micro screen cloth is shown employing a 18 continuous recessed shape out of which arises an upward extending shape 17 that further serves, referring to, referring to (FIG. 21) 17, 18, capture and redirect forward flowing water 5 downward. Referring to (FIGS. 20 and 21) 15, 16, it is illustrated that the recessed shapes with their upraised planes may exist as smaller segmented units.

### An Embodiment

### Denier: Thread Diameter

Prior and current employment of micro screen or micro cloth filtering elements existent in products that have come to market after the introduction of Leaffilter, Leaf Solution, and Master Shield have been limited by other inventors in field 52/12 and in products marketed as gutter guard devices to the same dimensioned micro screens or cloths I introduced to the market place from this field of invention. In general these filtration membranes range in thread count from 80 to 160 and with approximate thread diameters that range from 0.12 millimeters (common diameter of 80 mesh wire cloth) to 0.065 mm (common diameter of 160 mesh wire cloth).

I began to study improvements that might become evident by employing significantly smaller thread diametered cloth. For instance, a common thread diameter for 120 mesh stainless steel wire cloth is 0.08 mm with open air space between the threads of 0.132 mm. That thread diameter and open air space, when utilized in this field of invention, may very ten percent. I requested and tested micro screen samples that employed thread diameters not previously disclosed in this field. One sample in particular possessed a much improved ability to receive and pass water through from it's top to bottom surface while exhibiting little, if any, water sheeting on the top or bottom surface of the cloth. The cloth employed extremely fine or sheer diameter threads: 0.056 warp threads and 0.057 fill threads which achieved 51% air opening that is visually non apparent unless viewed under microscope. Unlike any previously tested or employed micro screen, this particular embodiment did not channel water forward throughout it's body when tilted at an angle, instead, the water drops straight through from top to bottom.

This property and others taught within this specification: resistance to water proofing and ability to rapidly dry, have, to the best of my knowledge, never been known or even imagined to exist in a densely (80 threads per inch or greater) threaded cloth configuration. The body of Specifications in this field that mention fine screens all state that they tend to shed water, including my own specifications found in my previously issued patents.

My U.S. Pat. No. 6,598,352 was the first to offer a solution to this problem; Robert Lenney acknowledged this in his U.S. Pat. No. 7,310,912: Column 1, lines 40-50: “some such prior art gutter debris guards utilize some form of screen which allows water to pass through but precludes debris. Such screen-based gutter debris guards presented difficult technical I problem. If the apertures in the screen are too large, then debris will pastor the openings in the screen causing the device to fail. If the openings are slightly smaller, the debris can become lodged within the apertures themselves, plugging up the apertures in providing a homeowner with a new challenge involved in cleaning debris out of the screen itself”. Lenny goes on to state in column 1 lines 61-67 and column 2 lines 1-3: “the patent to Higginbotham (U.S. Pat. No. 6,598,352) teaches one solution to this problem. In particular, the screen is supported from below by a series of vertical legs that extend up to elliptical heads which support the screen there on. With the elliptical heads of the legs in contact with the screen, adhesion forces in the water are beneficially utilized to provide a wetted path of surface material wicking the water down through the screen along these legs with the water is then further allowed to drop down into the gutter.” I would add to Mr. Lenny's statement that my patent offered not only one solution to the problem but, up until that time, the only solution to the problem that had ever been offered in field 52/12.

### Intrinsic Ability to Capture and Redirect Forward Flowing Water

However, unlike previously tested fine and micro screens and cloths that require a point of contact by a downward extending object on their underside to break the forward flow or sheeting of water, the unusually sheer 120 mesh that employed 0.056 and 0.057 diameter warp and fill threads, respectively, exhibited very little forward channeling of water when the sheer mesh cloth is tilted at angles. This is an important discovery because most gutter guards are tilted at angles more in line with roof pitch to facilitate the falling away of leaves and other debris: Any micro screen or cloth that possessed an intrinsic, unilateral-non-assisted-by-other structures, capability of breaking forward water flow while screening fine debris would enhance any prior art method's ability to capture forward flowing water and redirect it downward if such prior art employed fine or other filtering screens or cloths. The reason it would enhance is that the more easily and readily water is directed downward, the less opportunity there is for pollutants in the water to settle on screen and underlying surfaces and, for already deposited organic oil or scum accumulations present from pine needles and other debris, the more readily such pre-water flow existent pollutants will be cleaned and washed off of the screen and underlying surfaces.

For the purpose of this specification the term “sheer” will mean any cloth or micro screen composed of no fewer than 80 threads per inch, such threads exhibiting diameters At least 15% smaller than commonly used thread diameters used and published in catalog offerings by companies that manufacture micro screen or cloth products. As an example, most steel wire cloth manufacturers publish available thread diameters of approximately 0.08 mm for their manufacture of 120 mesh wire cloth. However, the “sheer” cloth I requested and tested, and not commonly offered, is composed of threads with diameters of 0.056 and 0.057 Which are approximately 30% smaller than the standard 0.08 mm thread found in 120 mesh stainless steel micro screen.

### Intrinsic Ability to Shed Oil

Of any micro screen cloth I've ever tested over the years, none has ever shed oil as this “sheer cloth” embodiment does. Pouring car oil or other oils on the cloth have almost no effect on it's ability to take water from it's top surface and direct it downward. Water almost instantaneously pushes through the oil and drops down through the cloth even when the cloth is tilted at angles. The “pour oil on it” test is a very good indicator of how well a product will or will not avoid water proofing in the field from leached shingle oil and other oil based pollutants.

### Intrinsic Ability to Rapidly Dry Observed by Karen Sager

The sheer cloth also took on a new property once water ended contact with it I observed the following: through a spectrum of water flow rates, ranging from large or small volumes of water flowed through this “sheer cloth,” at various velocities, in the manner described above. Once the water stopped, the cloth reacted in a manner not previously observed in other cloths, even ones that where technically of similar specifications, i.e., the same mesh/inch ratio. Specifically, other fine filter cloths remained wet in appearance (the cloth itself darkened the same way a cotton cloth does when it was wet) for a period of time commensurate with water evaporating as part of a natural drying process. Although the propensity of non “sheer cloth” to retain water has no immediate impact on the cloth's ability to take water if such non-sheer cloth is supported and contacted on it's undersurface as taught in prior art, the water retention by the non sheer cloths or micro screens encourage rather than discourage ice formation within the cloth. Additionally, such water retention is more likely to create an environment in which mold spores might grow.

While testing the new “sheer cloth,” once the water ended contact with its surface, the open space reacted in a significantly different manner; appearing to dry virtually instantaneously. With closer observation, the open air space in between the warp and weft of the cloth was not filled with water but remained open air. This test was repeated with oil and yielded the same results: the cloth reacted as if it'd never been in contact with the liquid appearing to dry in an indistinguishable amount of time. It did not collect water in ways other micro screens and cloths of prior art do. Normally, increasing the space between threads actually causes lengthier water bridges or mini water sheets to form between the threads and remain there until they evaporate. In the body of the sheer cloth, they tend to not form at all. In light of this normally occurring water retentive property existent in common micro screens and cloths it was not immediately apparent that “sheer cloth” would exhibit characteristics not seen in traditional weave patterns.

Referring to (FIGS. 21 and FIG. 22) there is illustrated a representation of a 3mt thread such as would be commonly employed in a micro screen cloth comprised of 120 threads per inch with an existent D thread diameter of 0.08 mm. There is also illustrated a representation of a 3mst thread with an existent D thread diameter of 0.057. Both sets of threads; the normal diameter and smaller diameter threads, are spaced 5sp equally apart. As is shown, the larger diameter threads have a larger 5c circumference for 5d larger amounts of water to congregate on and cling to than is found available on the 5sc smaller circumference of the smaller threads. This may explain the three new properties: 1. An intrinsic ability to capture and redirect water flow, 2. An intrinsic ability to either rapidly set well or allow for oil to be displaced by downward flowing water, and 3. An intrinsic ability to rapidly dry. Additionally, air spaces or bridges existent between smaller diameter threads spaced the same is larger diameter threads offers smaller water adhesive sidewalls or water adhesive 5c thread circumferences for water to cling to making it more likely for water to drop downward. In my prior art I realized and taught that water directing planes contacting the underside of micro screen capture and redirect water most effectively when the tops of those planes employ certain shapes and when the top of the planes tend toward narrow rather than wide dimensions. I believe that the smaller circumference of the smaller threads acts in a similar manner by offering a more narrow point or plaintiff contact between the top surface of the thread and the underside of water drops or sheets flowing over the thread. I do not, at this time, fully understand why there is far less forward under flow of water clinging to the bottom surface of “sheer” micro screens and cloth but have observed that this desirable property is existent in “sheer” micro screens and cloth. Although every cause for the newly discovered properties existent in sheer micro screens that may be employed in fields 51/12 may not be fully understood or identified what has been discovered and is now taught in the specification is that smaller than your threads allow for cloth or micro screens to exist in a plane whose vertical height varies only slightly from thread to thread regardless of the type of weave employed. The more the vertical height between threads can be reduced the more the properties disclosed in the specification become apparent. There are many methods of weaving metallic threaded cloth, those which employ crimping or other processes that reduce vertical height of the thread or thread junctures place threads more closely within the same horizontal plane and these types of weaves are preferred for the present invention. To the best of my knowledge, this disclosure as well as others taught within this specification have never been identified or taught in prior art.

Referring to (FIG. 23), it is shown that smaller diameter threads allow for greater threads per inch thread count in a micro screen while maintaining the same open air space that would exist in a micro screen employing fewer threads per inch with greater diameter. Testing has shown that this type of sheer micro screen also outperforms larger threaded micro screens possessing the same open air space when it comes to capturing and redirecting water flow, shedding oil or displacing oil in the presence of water flow, or rapidly drying.

It is understood that the present invention is not limited to any particular shape of thread. Threads with grooves, spiral grooves, or intermittent depressions or compressions serve to capture and channel water in unique ways and such threads may be utilized within embodiments described within this specification. Threads of different composition may offer desirable features such as interweaving copper threads with stainless steel to thwart moss or mildew growth. Varying thread sizes may allow for extremely sheer and high numbered thread count micro screens to be employed by this invention, for example: warp threads with diameters of 0.057 mm could be employed at 120 threads per inch for strength while weft threads of 0.03 mm diameter could be employed to achieve 300 threads per inch which may serve to screen or filter certain organisms from entering a rain gutter/gutter guard combination utilized for rain harvesting.

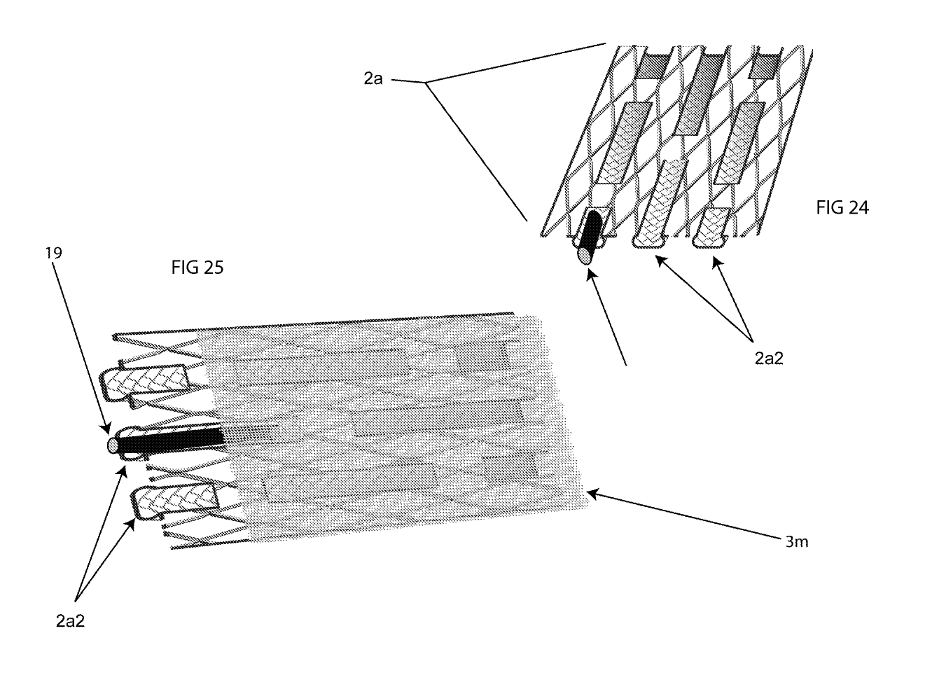

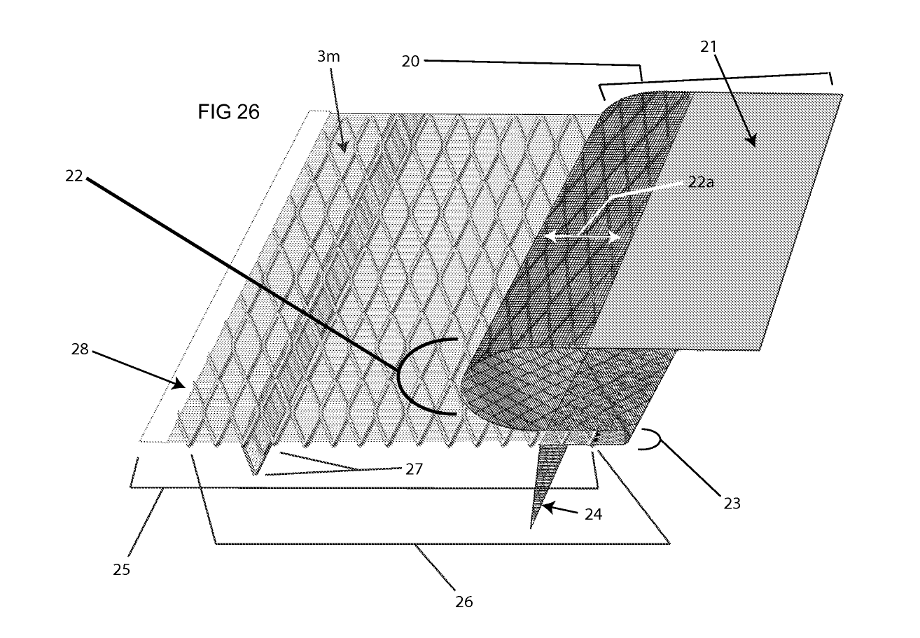

Referring to (FIG. 24,25) 2a2 recessed, downwardly depressed or embossed channels or wells are shown existing within the body of a metal plane expanded horizontally to the long side. It is also illustrated that elements 19 may be placed within these wells and then, referring to (FIG. 25), overlain by filtration membrane 3m. The preferred shape of these elements is round or oval since these shapes tend to capture water that contacts the top surface and directed downward. The elements may be zinc, copper, or other material that tends to release ions that prevent moss, mold, mildew, or other growth, or that aid in the filtration and purification of water.

Referring to (FIG. 26) there is illustrated an embodiment of the invention 20 shaped as a water receiving and water directing reverse curve 22 that incorporates on its underside a gutter guard element receiving channel 23 and downward extending drip plane 24. The gutter guard element 25 employs a water receiving plane composed of metal expanded horizontally to the long side 26, a water receiving and water directing downward extending inseam or channel 27 and a front plane 28 that rests on top of the top lip of a rain gutter. The expanded metal portion of gutter guard element 25 is overlain by a filtration membrane 3m.

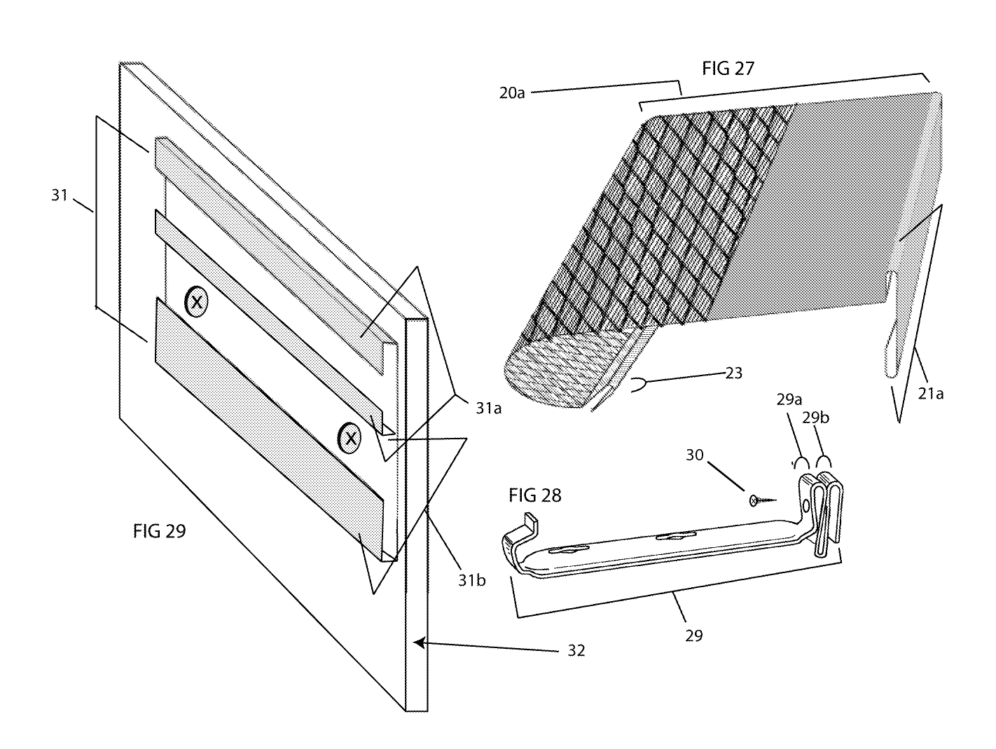

Referring to (FIG. 27) there is illustrated an embodiment of the invention 20a that incorporates at the rear of top plane 21 a male sleeve 21a that inserts into, referring to (FIG. 29), channel 31a: a component of gutter hanging assembly 31. Referring to (FIG. 28) gutter hanger 29 is shown that employees to rear hanging clips: 29a and 29b. A fastening element or screw 30 is also shown.

Referring to (FIG. 29) a gutter guard and rain gutter hanging assembly 31 is shown attached to a fascia board 32. The gutter guard hanging assembly employs a top receiving channel 31a and two which is inserted, Referring to (FIG. 27) the rear male sleeve 21a of embodiment 21a of the present invention. Referring again to (FIG. 29) assembly 31 is also illustrated as incorporating a lower receiving channel 31b.

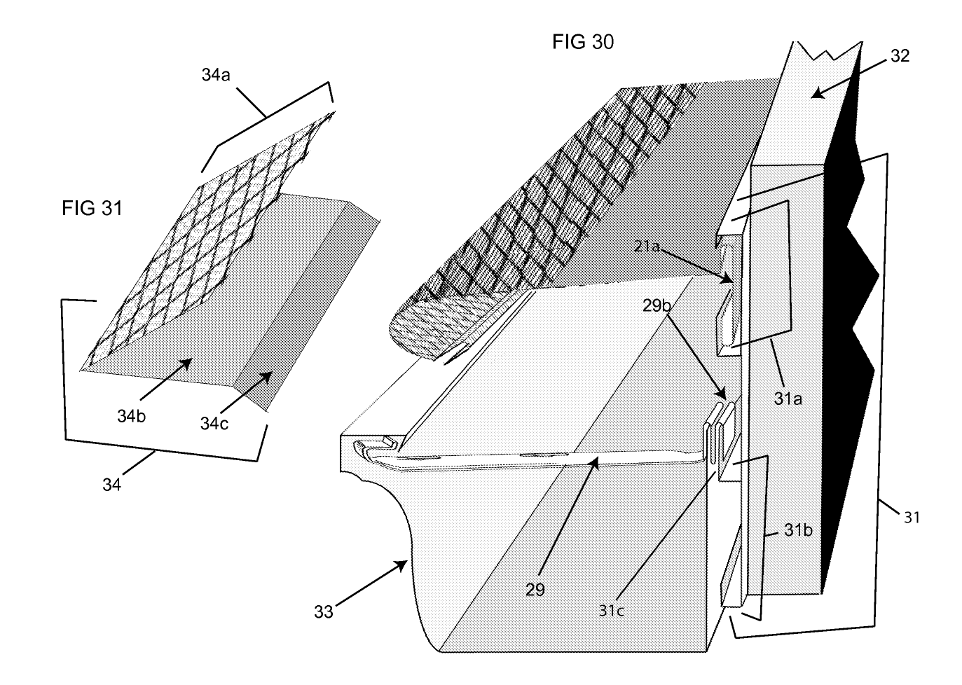

Referring to (FIG. 30) gutter guard at gutter hanging assembly 31 is shown attached to a fascia board 32. Embodiment 20a of the present invention is shown installed beneath (referring also to (FIG. 32) a roof structure by means of its rear male sleeve 21a being inserted into receiving channel 31a.

It is also illustrated that a rain gutter 33 is installed by means of gutter hanger 29 which utilizes rear clip 29b to loop over an upward extending plane 31c of receiving channel 31b.

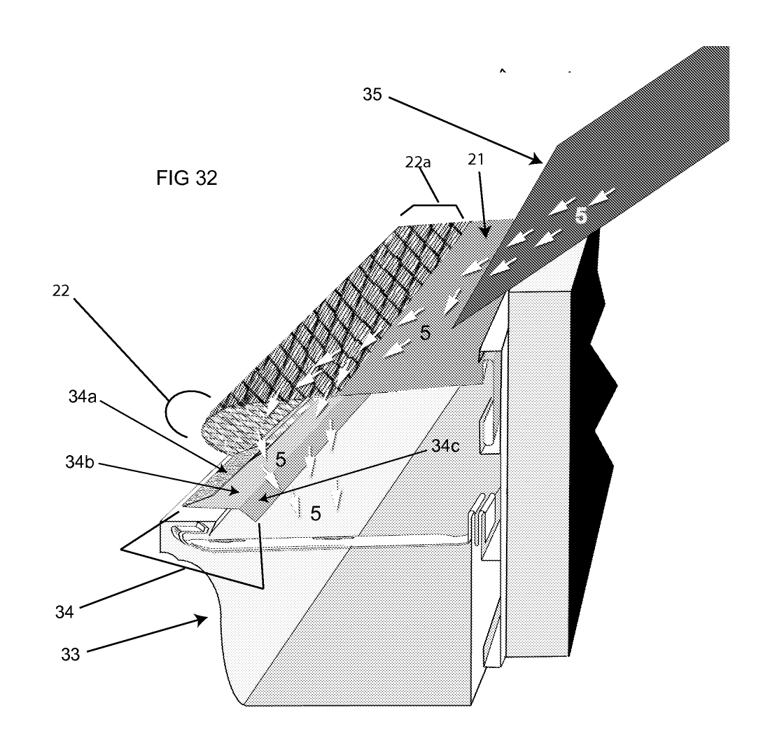

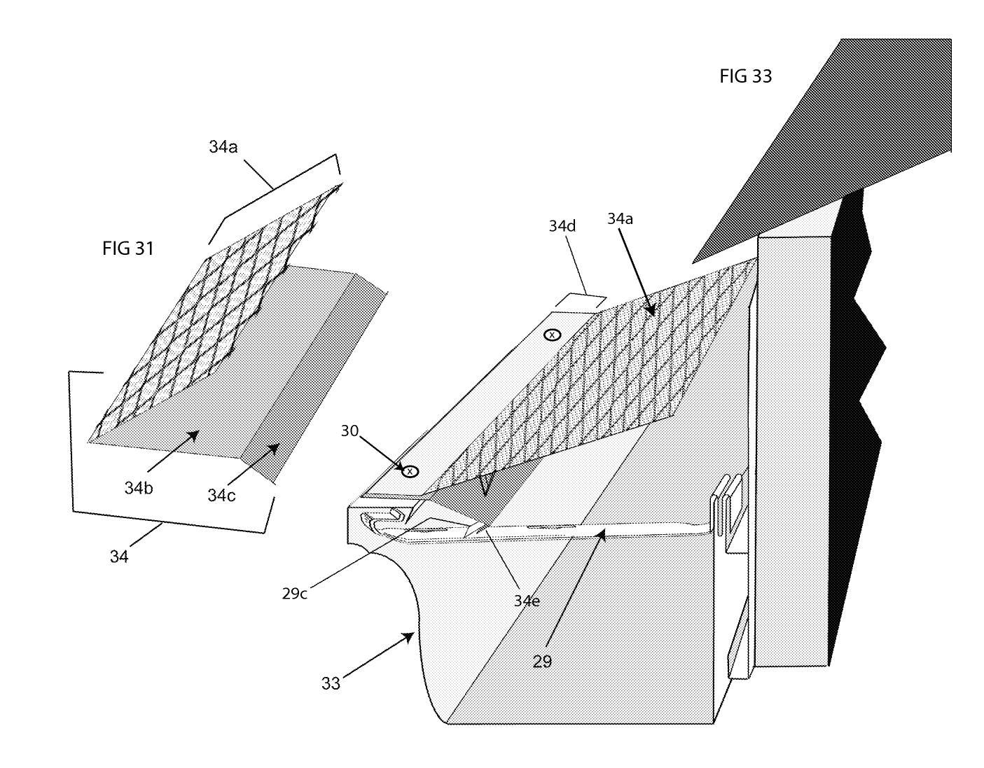

Referring to (FIG. 31) there is illustrated a illustration element composed of a water receiving area 34a, which is expanded metal or other porous structure overlain by filtration membrane, and also composed of a solid plane 34b integrally attached to 34a. Integrally attached to 34b is downward extending water directing plane 34c.

### Reverse Curve with Insertable Filtration Element

Referring to (FIG. 32) an embodiment of the present invention is shown installed beneath a roof membrane or structure 35 and illustrating water flow paths 5. Water 5 flows off the roof structure and contacts solid plane 21, which may be of any width and gauge of metal or material that allows for either flexibility or strength or both. Plane 21 should have sufficient strength and stiffness to retain it's angle of installation once installed. It is not necessary that the plane be solid: if it is comprised of expanded metal of sufficient strength and stiffness to retain angle of install, then expanded metal or any other porous material may be utilized to form plane 21. Plane 21 may also be somewhat flexible to allow the plane to be bent at different angles to match roof pitch, if desired, but the invention is not limited to this property. Water continues to flow forward and downward from plane 21 to water receiving plane 22a which, as shown is composed of metal expanded horizontally to the long side overlain by micro mesh or other filtering membrane. In any instance where the complete volume of forward flowing water is not directed downward through plane 22a but continues to flow forward it will be received and redirected downward both through and around reverse curve 22 if this curve is composed of metal expanded horizontally to the long side and overlain by a filtering membrane. This property is unique in that prior art has not utilized or described this type of water receiving area configured as a reverse curve that is water permeable across it's entire surface area: Curves with louvers or perforations or expanded metal or screens are found in prior art but none is found that teach a combination of metal expanded horizontally to the long side overlain by micromesh or any other filtering membrane.

Any amount of water that follows around reverse curve 22 will be directed to contact the water receiving area of upward extending plane 34a where it will fall through and downward contacting solid plane 34b and continuing to flow down plane 34c and into the underlying rain gutter. Planes 34a, 34b, and 34c comprise insertable filter element 34 which is shown inserted into the filter element receiving channel of embodiment 22 of the invention. Plane 34b rests on the top lip of rain gutter 34.

Referring to (FIG. 27) 20b, this reverse curved embodiment of the present invention may employ a rear plane or sleeve 21a that is perpendicular to Water Directing Drip Edge element 20a. that may be inserted, referring to (FIGS. 29 and 30) into receiving channel 31a of receiving member 31.

Referring to (FIG. 33) insertable element 34 may serve as a stand-alone gutter guard. In such an embodiment water receiving plane 34a would be of greater length than is illustrated in (FIG. 21) and may be adjusted upward as needed. As a stand-alone gutter guard element 34 may employ a fastening shelf 34d integrally attached to water receiving area 34a. Fastening members such as screws 30 may be used to secure 34d to the top lip of the rain gutter 33. The lower plane of 34d would continue to extend downward into water directing planes 34b which would reverse angle and extend downward into engaging plane 34e. Engaging plane 34e would hook beneath upward extending plane 29c which is an integral member of gutter hanger 29.

### REFERENCE NUMERALS

1 common expanded metal gutter guard
1a common vertical expanded metal pattern comprised of expanded openings that have a vertical length greater than their horizontal width as they traverse a length of slit expanded metal
1a1 Expanded opening exhibiting a vertical height greater than it's horizontal width
1b rear metal band
1c front metal band
1d rear metal plane
1e front metal band and downward securing member embodiment of the invention
2a horizontal expanded metal pattern comprised of expanded metal openings that have a horizontal width greater than their vertical length as they traverse a length of slit expanded metal
2a1 expanded metal opening exhibiting a horizontal width greater than it's vertical height
3 exploded view of an expanded opening exhibiting a vertical height greater than it's width
3a top surface of the upper right linear segment of a vertical expanded metal opening
3b bottom surface of the right linear segment of a vertical expanded metal opening
3c top surface of a mid linear segment “knuckle” of a vertical expanded metal opening
3d bottom surface of a mid linear segment “knuckle” of a vertical expanded metal opening
3e top surface of the lower right linear segment of a vertical expanded metal opening
3f bottom surface of the lower right linear segment of a vertical expanded metal opening
3g top surface of the lower left linear segment of a vertical expanded metal opening
3h bottom surface of the lower left linear segment of a vertical expanded metal opening
3i top surface of a mid linear segment “knuckle” of a vertical expanded metal opening
3j bottom surface of a mid linear segment “knuckle” of a vertical expanded metal opening
3k top surface of the upper left linear segment of a vertical expanded metal opening
3L bottom surface of the upper left linear segment of a vertical expanded metal opening
3m sheer micro mesh or other filtration membrane
3mwarp threads positioned vertically In a cloth or screen
3mweft threads positioned horizontally in a cloth or screen
3mi Upward embossed “island” rising out of a downward embossed or recessed rectangular shaped depression in the micro screen that transverses the entire length of the micro screen
3msi upward embossed “islands” rising out of multiple separated downward embossed or recessed rectangular shaped depressions present in the micro screen cloth
3mst smaller diameter thread
3mt larger diameter thread
3mts top surface of micromesh or other filter membrane
3mr recessed rectangular shape transversing the length of the micro screen
3msr separated segmented rectangular shape
3mdi downward extending inseam exploded view of an expanded opening exhibiting a linear width greater than it's vertical height
4a top surface of the upper right linear segment of a vertical expanded metal opening
4b bottom surface of the right linear segment of a vertical expanded metal opening
4c top surface of a mid linear segment “knuckle” of a vertical expanded metal opening
4d bottom surface of a mid linear segment “knuckle” of a vertical expanded metal opening
4e top surface of the lower right linear segment of a vertical expanded metal opening
4f bottom surface of the lower right linear segment of a vertical expanded metal opening
4g top surface of the lower left linear segment of a vertical expanded metal opening
4h bottom surface of the lower left linear segment of a vertical expanded metal opening
4i top surface of a mid linear segment “knuckle” of a vertical expanded metal opening
4j bottom surface of a mid linear segment “knuckle” of a vertical expanded metal opening
4k top surface of the upper left linear segment of a vertical expanded metal opening
4L bottom surface of the upper left linear segment of a vertical expanded metal opening
4m segment of an expanded metal opening that has been corrugated
4n horizontal width of expanded opening expanded horizontally to the longside
4o vertical height of expanded opening expanded horizontally to the longside
4p center member of an expanded metal opening
ab° angle of degree
s1 right upper sidewall of expanded metal opening
s2 right lower sidewall of expanded metal opening
s3 bottom sidewall or “knuckle” of expanded metal opening
s4 left bottom sidewall of expanded metal opening
s5 left upper sidewall of expanded metal opening
s6 upper sidewall or “knuckle” of expanded metal opening water flow path
5a water flow path around curved and recessed, sidewall
5b water flow path around shaped and recessed sidewall
5c thread circumference
5d drops of water
5sp space between threads
5sc thread circumference of smaller diameter thread
6 rain gutter
7 fascia board
8 roof shingles
9 heart shapes depressed or embossed downward into a metallic thread micro screen
10 animal footprints depressed or embossed downward into a metallic thread micro screen
11 bowtie shape depressed or embossed downward into a metallic thread micro screen
12 8 sided polygon shape depressed or embossed downward into a metallic thread micro screen
13 word phrase: “Alex Rules” depressed or embossed downward into a metallic thread micro screen
14 word phrase: “Karen Rules” depressed or embossed downward into a metallic thread micro screen
15 tapered recessed rectangular shape: part of a segmented pattern
16 upraised emboss
17 tapered recessed rectangular shape that is continuous and unbroken
18 continuous upraised emboss
19 insertable element
20 Water Directing Drip Edge element
20a Water Directing Drip Edge element with rear insertable sleeve
20b Embodiment of the invention illustrating a rear insertable sleeve
21 Rear Plane
21a Rear vertical plane serving as insertable sleeve
22 Reverse curved plane composed of a “2a” type of expanded metal overlain by a filtration membrane
22a Water receiving plane
23 receiving channel composed of 2a type expanded metal overlain by a filtration membrane
24 downward extending drip edge composed of 2a type expanded metal overlain by A filtration membrane
25 Gutter Guard element composed of 2a type expanded metal overlain by a filtration membrane
26 2a type expanded metal
27 Downward extending inseam composed of 2a type expanded metal overlain by a filtration membrane
28 front rain gutter engaging edge
29 Gutter Hangar with 2 rear clips
29a Rear clip a
29b Rear clip b
29c upward extending clip
30 Fastening member
31 Gutter Mounting Rail
31a Gutter Guard receiving channel
31b Gutter Clip or Gutter Rear wall receiving channel
31c upward extending plane of 31a
32 fascia board
33 rain gutter
33a front top lip of a rain gutter
34 insertable filter
34a water receiving plane of insertable plane 34
34b lower solid plane of insertable filter 34
34c lower solid drip plane of insertable filter 34
34d roll formed double plane or extruded single plane that serves as a fastening member for insertable filter 34
34f rear planar portion of insertable filter 34
34e downward extending engaging element of insertable filter 34
D thread diameter
rd rectangular recess, depression or emboss in the top surface of a filter cloth or membrane
SWD short way of the diamond: a term that indicates punched diamond openings, that comprise expanded metal, have their shorter open air spaces positioned parallel to the long edge of an expanded metal sheet or roll.
LWD long way of the diamond: a term that indicates punched diamond openings, that comprise expanded metal, have their longer open air spaces positioned parallel to the long edge of an expanded metal sheet or roll.

I claim:

1. A rain gutter filtering assembly comprising:
a filtering membrane with a top surface and a bottom surface, the filtering membrane comprising threads; and
a perforated skeletal structure beneath and supporting the filtering membrane and having a top surface and a bottom surface, the bottom surface of the filtering membrane contacting the top surface of the skeletal structure, wherein the skeletal structure forms a plurality of downward extending channels each of which has two opposing side walls that are spaced apart from one another and extend substantially parallel to one another to direct water downward from the top surface of the skeletal structure screen assembly, and wherein the filtering membrane suspends over open air space existent between the two opposing side walls of each downward extending channel.

2. The rain gutter filtering assembly according to claim 1, wherein the skeletal structure comprises expanded metal material including perforations or openings having a width greater than or equal to ⅜ inch.

3. The rain gutter filtering assembly according to claim 1, wherein the filtering membrane is attached to or rests on inner surfaces of the two opposing sidewalls of each downward extending channel, and wherein the skeletal structure comprises expanded metal material.

4. A rain gutter filtering assembly comprising expanded metal overlain by a filtering membrane, said expanded metal having open-air-space openings existent between sidewall members; said openings having an open air space width and a larger open air space length, the length being parallel to a building's fascia board, said openings having more than one sidewall member angled upward and toward oncoming water flow flowing off a building's roof.
